(19) United States
(12) Patent Application Publication
(10) Pub. No.: US 2016/0018578 A1
(43) Pub. Date: Jan. 21, 2016

(54) POLARIZATION PLATE, METHOD FOR MANUFACTURING SAME, AND IMAGE DISPLAY DEVICE

(71) Applicant: FUJIFILM CORPORATION, Tokyo (JP)

(72) Inventors: Takashi YONEMOTO, Kanagawa (JP); Naoyoshi YAMADA, Kanagawa (JP); Hiromichi FURUKAWA, Kanagawa (JP); Ryuji SANETO, Kanagawa (JP); Kazuya HISANAGA, Kanagawa (JP)

(73) Assignee: FUJIFILM CORPORATION, Tokyo (JP)

(21) Appl. No.: 14/867,072

(22) Filed: Sep. 28, 2015

Related U.S. Application Data
(63) Continuation of application No. PCT/JP2014/060814, filed on Apr. 16, 2014.

(30) Foreign Application Priority Data
Apr. 19, 2013 (JP) 2013-088799

(51) Int. Cl. G02B 5/30; G02B 1/14

(52) U.S. Cl. CPC G02B 5/305; G02B 1/14

(57) ABSTRACT

A polarization plate includes a polarizer having polarization performance; a first protective film bonded to one surface of the polarizer through an adhesive layer 1; and a second protective film bonded to the other surface of the polarizer through an adhesive layer 2, in which a modulus of elasticity of the first protective film at 25° C. and relative humidity of 60% in an absorption axis direction of the polarizer is greater than or equal to 1.0 GPa and less than 4.0 GPa, a ratio of the modulus of elasticity of the first protective film at 25° C. and relative humidity of 60% in the absorption axis direction of the polarizer to a modulus of elasticity of the first protective film at 25° C. and relative humidity of 60% in a direction orthogonal to the absorption axis of the polarizer is less than or equal to 0.8, a modulus of elasticity of the second protective film at 25° C. and relative humidity of 60% in the absorption axis direction of the polarizer is greater than or equal to 2.0 GPa and less than 5.0 GPa, and (Expression 1) and (Expression 2) described below are satisfied, suppresses curling of the polarizer in the absorption axis direction (d1 and d2 are thicknesses of the first protective film and the second protective film (unit: μm)).

d2/d1≦0.8; (Expression 1)

d2≦40 μm (Expression 2)

### CROSS-REFERENCE TO RELATED APPLICATIONS

This application is a Continuation of PCT International Application No. PCT/JP2014/060814, filed on Apr. 16, 2014, which claims priority under 35 U.S.C. Section 119(a) to Japanese Patent Application No. 2013-088799 filed on Apr. 19, 2013. Each of the above applications is hereby expressly incorporated by reference, in its entirety, into the present application.

### BACKGROUND OF THE INVENTION

1. Field of the Invention

The present invention relates to a polarization plate, a method for manufacturing the same, and an image display device.

2. Description of the Related Art

In an image display device such as a liquid crystal display (LCD), a plasma display (PDP), an electroluminescence display (OELD or IELD), a field emission display (FED), a touch panel, and an electronic paper, a polarization plate is arranged on a display screen side of an image display panel. For example, a liquid crystal display device has been variously used as a space saving image display device having low power consumption over the year. In the related art, the liquid crystal display device has a major defect of having significant view angle dependency of a display image, but a wide view angle liquid crystal mode such as a VA mode, and an IPS mode has been commercialized, and thus a demand for the liquid crystal display device has been rapidly expanded even in the television market or the like where a high definition image is required.

The polarization plate used in the liquid crystal display device generally includes a polarizer formed of a polyvinyl alcohol film in which iodine or a dye is adsorbed and aligned, or the like, and transparent protective films (polarization plate protective films) bonded onto both the front and back sides of the polarizer. For the sake of convenience, a protective film on a surface to be bonded to a liquid crystal cell (a side opposite to a display side) is referred to as an inner side film, and a protective film on a facing side (the display side) is referred to as an outer side film. A polyester resin, a polycarbonate resin, or the like has advantages such as low cost, high mechanical strength, and low moisture permeability, and thus is expected to be used as the outer side film.

For example, as a polarization plate protective film having suppressed rainbow unevenness, a polyester film in which retardation is set to be greater than usual by stretching the film mainly in a monoaxial direction, and thus rainbow unevenness is rarely visible is considered to be used (refer to WO2011/162198A). Furthermore, such a film has anisotropy in a ratio of moduli of elasticity in two orthogonal directions.

On the other hand, in JP2011-123401A, as the inner side film, diacetyl cellulose (hereinafter, also referred to as DAC), cellulose acetate propionate (hereinafter, also referred to as CAP), triacetyl cellulose (hereinafter, also referred to as TAC), and the like are used from a viewpoint of optical development properties or of being suitable for adhesion of water dispersion. Furthermore, it is known that such a film generally has anisotropy in order to provide optical compensation of a liquid crystal display device in a VA mode in particular, and the modulus of elasticity of the polarizer at 25° C. and relative humidity of 60% in a direction in parallel with an absorption axis of the polarizer is approximately greater than or equal to 2.0 GPa and less than 5.0 GPa.

In JP2012-048181A, a polarization plate using a protective film formed of a polyethylene terephthalate (hereinafter, also referred to as PET)-based resin and a protective film formed of a TAC-based resin is disclosed. An object of JP2012-048181A is to prevent curling from occurring in a manufacturing step of the polarization plate, and in JP2012-048181A, it is disclosed that the problem of the occurrence of curling is able to be solved by setting the film thickness of the protective film formed of the PET-based resin and the film thickness of the protective film formed of the TAC-based resin to be approximately symmetric film thicknesses.

### SUMMARY OF THE INVENTION

However, the present inventors have prepared a polarization plate by combining the outer side film having anisotropy in a ratio of moduli of elasticity in two orthogonal directions and the inner side film having a specific modulus of elasticity, and by aligning a direction of the outer side film in which the modulus of elasticity of the outer side film was low and the absorption axis direction of the polarizer, and have found that the polarization plate was curled in the absorption axis direction of the polarizer. In particular, as disclosed in JP2012-048181A, it was not known in the related art that the problem of the occurrence of curling was not able to be sufficiently solved even when the film thicknesses of the inner side film and the outer side film were set to be approximately symmetric film thicknesses.

In addition, it was known that in such a polarization plate which was curled in the absorption axis direction of the polarizer, air bubbles or foreign substances entered at the time of bonding the polarization plate to the liquid crystal cell.

An object of the present invention is to provide a polarization plate in which curling of a polarizer in an absorption axis direction of the polarizer is suppressed.

As a result of intensive studies of the present inventors for attaining the object described above, it has been found that the inner side film having the specific modulus of elasticity is thinned at the time of using the outer side film having the anisotropy in the ratio of the moduli of elasticity in two orthogonal directions, and a ratio of thicknesses of the inner side and outer side protective films decreases such that the thickness of the inner side film is less than or equal to a specific range, and thus the object described above is able to be attained.

That is, the object described above is attained by the present invention having the following configurations.

[1] A polarization plate including a polarizer having polarization performance; a first protective film bonded to one surface of the polarizer through an adhesive layer 1; and a second protective film bonded to the other surface of the polarizer through an adhesive layer 2, in which a modulus of elasticity of the first protective film at 25° C. and relative humidity of 60% in an absorption axis direction of the polarizer is greater than or equal to 1.0 GPa and less than 4.0 GPa, a ratio of the modulus of elasticity of the first protective film at 25° C. and relative humidity of 60% in the absorption axis direction of the polarizer to a modulus of elasticity of the first protective film at 25° C. and relative humidity of 60% in a direction orthogonal to the absorption axis of the polarizer is less than or equal to 0.8, a modulus of elasticity of the second protective film at 25° C. and relative humidity of 60% in the absorption axis direction of the polarizer is greater than or equal to 2.0 GPa and less than 5.0 GPa, and (Expression 1) and (Expression 2) described below are satisfied.

d2/d1≦0.8 (Expression 1)

d2≦40 μm (Expression 2)

(In Expression 1 and Expression 2, d1 represents a thickness of the first protective film (unit: μm), and d2 represents a thickness of the second protective film (unit: μm).)

[2] In the polarization plate according to [1], it is preferable that the first protective film is a film containing a polyester resin or a polycarbonate resin as a main component.

[3] In the polarization plate according to [1] or [2], it is preferable that a ratio of the modulus of elasticity of the second protective film at 25° C. and relative humidity of 60% in the absorption axis direction of the polarizer to a modulus of elasticity of the second protective film at 25° C. and relative humidity of 60% in the direction orthogonal to the absorption axis of the polarizer is greater than or equal to 0.6 and less than 1.1.

[4] In the polarization plate according to any one of [1] to [3], it is preferable that the second protective film contains a cellulose-based resin.

[5] In the polarization plate according to [4], it is preferable that a degree of substitution of an acyl group of the cellulose-based resin contained in the second protective film is greater than or equal to 2.0 and less than 2.6.

[6] A method for manufacturing a polarization plate including bonding a first protective film to one surface of a polarizer having polarization performance through an adhesive layer 1; and bonding a second protective film to the other surface of the polarizer through an adhesive layer 2, in which a modulus of elasticity of the first protective film at 25° C. and relative humidity of 60% in an absorption axis direction of the polarizer is greater than or equal to 1.0 GPa and less than 4.0 GPa, a ratio of the modulus of elasticity of the first protective film at 25° C. and relative humidity of 60% in the absorption axis direction of the polarizer to a modulus of elasticity of the first protective film at 25° C. and relative humidity of 60% in a direction orthogonal to the absorption axis of the polarizer is less than or equal to 0.8, a modulus of elasticity of the second protective film at 25° C. and relative humidity of 60% in the absorption axis direction of the polarizer is greater than or equal to 2.0 GPa and less than 5.0 GPa, and (Expression 1) and (Expression 2) described below are satisfied.

d2/d1≦0.8 (Expression 1)

d2≦40 μm (Expression 2)

(In Expression 1 and Expression 2, d1 represents a thickness of the first protective film (unit: μm), and d2 represents a thickness of the second protective film (unit: μm).)

[7] In the method for manufacturing a polarization plate according to [6], it is preferable that a modulus of elasticity of the second protective film at 70° C. and relative humidity of 60% in the absorption axis direction of the polarizer is 1.5 GPa to 3.0 GPa, and a main component of the adhesive layer 1 and the adhesive layer 2 is an aqueous adhesive agent.

[8] An image display device comprising the polarization plate according to any one of [1] to [5].

According to the present invention, it is possible to provide a polarization plate in which curling of a polarizer in an absorption axis direction of the polarizer is suppressed.

### BRIEF DESCRIPTION OF THE DRAWINGS

FIG. 1 is a schematic view illustrating a sectional surface of an example of a polarization plate of the present invention.

FIG. 2 is a schematic view illustrating a sectional surface of an example of an image display device of the present invention.

### DESCRIPTION OF THE PREFERRED EMBODIMENTS

Hereinafter, a polarization plate and an image display device of the present invention will be described in detail.

The following description of configuration requirements is based on a representative embodiment of the present invention, but the present invention is not limited to such an embodiment. Furthermore, herein, a numerical range denoted by using “to” indicates a range including the numerical values before and after “to” as the lower limit value and the upper limit value.

[Polarization Plate]

A polarization plate of the present invention includes a polarizer having polarization performance, a first protective film bonded to one surface of the polarizer through an adhesive layer 1, and a second protective film bonded to the other surface of the polarizer through an adhesive layer 2, a modulus of elasticity of the first protective film at 25° C. and relative humidity of 60% in an absorption axis direction of the polarizer is greater than or equal to 1.0 GPa and less than 4.0 GPa, a ratio of the modulus of elasticity of the first protective film at 25° C. and relative humidity of 60% in the absorption axis direction of the polarizer to a modulus of elasticity of the first protective film at 25° C. and relative humidity of 60% in a direction orthogonal to the absorption axis of the polarizer is less than or equal to 0.8, a modulus of elasticity of the second protective film at 25° C. and relative humidity of 60% in the absorption axis direction of the polarizer is greater than or equal to 2.0 GPa and less than 5.0 GPa, and the polarization plate satisfies (Expression 1) and (Expression 2) described below.

d2/d1≦0.8 (Expression 1)

d2≦40 μm (Expression 2)

(In Expression 1 and Expression 2, d1 represents a thickness of the first protective film (unit: μm), and d2 represents a thickness of the second protective film (unit: μm).)

According to such a configuration, in the polarization plate of the present invention, curling of the polarizer in the absorption axis direction of the polarizer is suppressed. Here, a contractile force of the protective film is denoted by Dimensional Change of Thickness of Protective Film×Modulus of Elasticity of Protective Film×Protective Film, and in the present invention, the moduli of elasticity of the first and second protective films are set to be in a specific range, and a relationship between the thicknesses of the first and second protective films is set to be in a specific range, and thus curling is able to be suppressed.

Furthermore, in the polarization plate of the present invention, in particular, the curling of the polarizer in the absorption axis direction, that is, curling in an MD direction described below is able to be suppressed, and there is no particular problem of the occurrence of curling in a TD direction when the curling in the MD direction is completely removed.

<Configuration>

First, the configuration of the polarization plate of the present invention will be described with reference to the drawings.

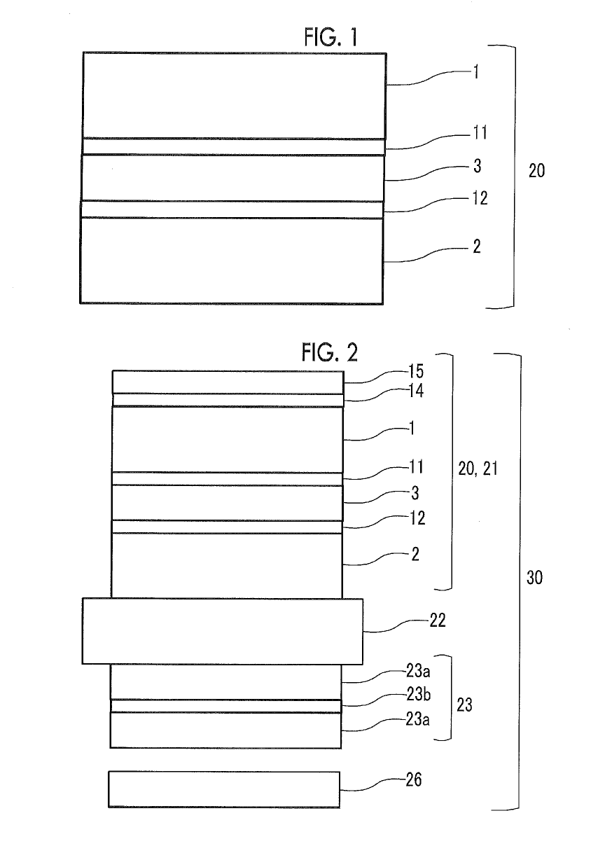

The polarization plate of the present invention includes the first protective film, the polarizer, and the second protective film in this order. An example of the polarization plate of the present invention is illustrated in FIG. 1. The polarization plate in FIG. 1 (a reference numeral of 20 in the drawing) includes the polarizer (a reference numeral of 3 in the drawing) having polarization performance, the first protective film (a reference numeral of 1 in the drawing) bonded to one surface of the polarizer through the adhesive layer 1 (a reference numeral of 11 in the drawing), and the second protective film (a reference numeral of 2 in the drawing) bonded to the other surface of the polarizer through the adhesive layer 2 (a reference numeral of 12 in the drawing).

The polarization plate may be a polarization plate in the shape of a film piece cut into a size at which the polarization plate is able to be directly incorporated in a liquid crystal display device, and also may be a polarization plate which is prepared into an elongated shape due to continuous production, and is wound into the shape of a roll (for example, a roll having a length of greater than or equal to 2500 m or 3900 m). In order to use the polarization plate in a large screen liquid crystal display device, it is preferable that the width of the polarization plate is greater than or equal to 1470 mm.

(Other Layers)

The polarization plate of the present invention may include other layers in addition to the first protective film, the adhesive layer 1, the polarizer, the adhesive layer 2, and the second protective film. As the other layer, an easily adhesive layer, a hard coat layer, and other known functional layers are able to be included. In the polarization plate of the present invention, it is preferable that the easily adhesive layer and the hard coat layer are arranged on the first protective film in order to prevent reflection, to suppress glare, or to suppress flaws.

In FIG. 2, an example of an image display device (a reference numeral of 30 in the drawing) of the present invention in which the polarization plate of the present invention is used as a visible side polarization plate (reference numerals of 20 and 21 in the drawing) is illustrated. In the polarization plate of the present invention illustrated in FIG. 2, the easily adhesive layer (a reference numeral of 14 in the drawing) and the hard coat layer (a reference numeral of 15 in the drawing) are arranged on the first protective film (a reference numeral of 1 in the drawing).

As the other known functional layer, an antireflection layer, a brightness enhancing layer, a forward scattering layer, an antiglare layer, and the like are included. The antireflection layer, the brightness enhancing layer, the forward scattering layer, the antiglare layer, and the other functional layers are disclosed in paragraph numbers “0257” to “0276” of JP2007-86748A, and a polarization plate which is functionalized on the basis of the disclosures is able to be prepared. In addition, as the other functional layer, an optical anisotropic layer may be formed.

As described above, among two polarization plate protective films, a film on a side which becomes a liquid crystal cell side at the time of bonding the polarization plate to a liquid crystal cell is referred to as an inner side film, and a film on a side opposite to the inner side film is referred to as an outer side film. It is preferable that the second protective film is the inner side film, and the first protective film is the outer side film.

It is preferable that the polarization plate is configured by bonding a protective film onto one surface of the polarization plate, and by bonding a separate film onto a surface opposite to the one surface.

The protective film and the separate film are used for protecting the polarization plate at the time of shipping the polarization plate, or performing product inspection, or the like. In this case, the protective film is bonded to the surface of the polarization plate in order to protect the surface, and is used on a surface side opposite to the surface of the polarization plate which is bonded to a liquid crystal plate. In addition, the separate film is used in order to cover an adhesive layer which is bonded to the liquid crystal plate, and is used on both sides of the polarization plate which are bonded to the liquid crystal plate.

The polarization plate may further include the adhesive layer, and when the polarization plate includes the adhesive layer, it is preferable that the polarization plate includes the first protective film, the polarizer, the second protective film, and the adhesive layer in this order. When the polarization plate having such a configuration is incorporated in the liquid crystal display device, it is preferable that the adhesive layer is bonded to the liquid crystal cell. When the adhesive layer is bonded to the liquid crystal cell side, the second protective film is the inner side film, and the first protective film is the outer side film.

Hereinafter, a preferred aspect of the polarizer and the protective film configuring the polarization plate of the present invention, and a manufacturing method thereof will be described.

<Polarizer>

The polarization plate of the present invention includes the polarizer having polarization performance.

As the polarizer, polarizers which are manufactured by a known method of the related art are able to be used, and among them, a polyvinyl alcohol-based polarizer is preferable, and the following thin polarizers are more preferable. As the thin polarizer, for example, a polarizer in which a film formed of a hydrophilic polymer such as polyvinyl alcohol or ethylene modified polyvinyl alcohol having a content of an ethylene unit of 1 mol % to 4 mol %, a degree of polymerization of 2000 to 4000, and a degree of saponification of 99.0 mol % to 99.99 mol % is stretched by being treated with a dichroic dye such as iodine, and a polarizer in which a plastic film such as vinyl chloride is treated and aligned are used.

In addition, as a method of obtaining a thin polarizer film of less than or equal to 10 μm by stretching and dyeing the polarizer film in a state of a laminated film in which a polyvinyl alcohol layer is formed on a substrate, methods disclosed in JP5048120B, JP5143918B, JP5048120B, JP4691205B, JP4751481B, and JP4751486B are able to be included, and a known technology relevant to these polarizers is also able to be preferably used in the polarization plate of the present invention.

(Film Thickness of Polarizer)

The film thickness of the polarizer is not particularly limited, but is preferably greater than or equal to 5 μm and less than or equal to 30 μm, and is more preferably greater than or equal to 10 μm and less than or equal to 20 μm from a viewpoint of the degree of polarization and warping. When the film thickness of the polarizer is less than or equal to 30 μm, the contractile force of the polarizer does not increase, the warping of a liquid crystal panel to which the polarizer is bonded does not increase, and thus setting the film thickness of the polarizer to be less than or equal to 30 μm is preferable. On the other hand, when the film thickness of the polarizer is greater than or equal to 5 μm, one polarization light ray which is transmitted through the polarizer is able to be sufficiently absorbed, and the degree of polarization does not decrease, and thus setting the film thickness of the polarizer to be greater than or equal to 5 μm is preferable.

<First Protective Film>

The polarization plate of the present invention includes the first protective film bonded to one surface of the polarizer through the adhesive layer 1, in which the modulus of elasticity of the first protective film at 25° C. and relative humidity of 60% in the absorption axis direction of the polarizer is greater than or equal to 1.0 GPa and less than 4.0 GPa, and the ratio of the modulus of elasticity of the first protective film at 25° C. and relative humidity of 60% in the absorption axis direction of the polarizer to the modulus of elasticity of the first protective film at 25° C. and relative humidity of 60% in the direction orthogonal to the absorption axis of the polarizer is less than or equal to 0.8.

(Resin)

A main component of the first protective film is not particularly limited, and it is preferable that, in the polarization plate of the present invention, the first protective film contains a resin such as a polyester resin or a polycarbonate resin as a main component.

It is preferable that the first protective film is a film containing a thermoplastic resin such as a polyester resin or a polycarbonate resin as a main component, and the first protective film may be a single layer film containing a resin such as a polyester resin or a polycarbonate resin as a main component or may be a multi-layer film including a layer containing a resin such as a polyester resin or a polycarbonate resin as a main component. In addition, both surfaces or one surface of the single layer film or the multi-layer film may be subjected to a surface treatment, and this surface treatment may be surface modification using a corona treatment, a saponification treatment, a heat treatment, ultraviolet irradiation, electron beam irradiation, and the like, or may be thin film formation using coating or deposition of a polymer, metal, or the like. The mass ratio of a resin such as a polyester resin or a polycarbonate resin with respect to the total mass of the film is generally greater than or equal to 50 mass %, is preferably greater than or equal to 70 mass %, is more preferably greater than or equal to 90 mass %.

—Polyester Resin—

It is preferable that the first protective film contains a polyester resin as a main component.

As the polyester, for example, polyethylene terephthalate, polyethylene isophthalate, polyethylene 2,6-naphthalate, polybutylene terephthalate, and 1,4-cyclohexane dimethylene terephthalate are included, as necessary, and two or more thereof may be used. Among them, polyethylene terephthalate is preferably used.

The polyethylene terephthalate is polyester having a constituent unit derived from a terephthalic acid as dicarboxylic acid component and a constituent unit derived from ethylene glycol as a diol component, may contain ethylene terephthalate in the amount of greater than or equal to 80 mol % with respect to the total repeating unit, and may contain a constituent unit derived from other copolymerization components. As the other copolymerization component, a dicarboxylic acid component such as an isophthalic acid, a p-β-oxyethoxy benzoic acid, 4,4′-dicarboxy diphenyl, 4,4′-dicarboxy benzophenone, bis(4-carboxy phenyl) ethane, an adipic acid, a sebacic acid, a 5-sodium sulfoisophthalic acid, and 1,4-dicarboxy cyclohexane, and a diol component such as propylene glycol, butane diol, neopentyl glycol, diethylene glycol, cyclohexane diol, an ethylene oxide adduct of bisphenol A, polyethylene glycol, polypropylene glycol, and polytetramethylene glycol are included. Two or more types of the dicarboxylic acid component and the diol component are able to be used in combination, as necessary. In addition, an oxy carboxylic acid such as a p-oxy benzoic acid is also able to be used in combination with the dicarboxylic acid component and the diol component described above. As the other copolymerization component, a dicarboxylic acid component and/or a diol component containing a small amount of amide bonds, urethane bonds, ether bonds, carbonate bonds, and the like may be used. As a manufacturing method of the polyethylene terephthalate, an arbitrary manufacturing method such as a so-called direct polymerization method in which a terephthalic acid, ethylene glycol, and as necessary, other dicarboxylic acids and/or other diols directly react with each other, and a so-called transesterification method in which dimethyl ester of a terephthalic acid, ethylene glycol, and as necessary, dimethyl ester of other dicarboxylic acids and/or other diols are transesterified is able to be applied.

—Polycarbonate Resin—

It is also preferable that the first protective film contains a polycarbonate resin as a main component.

A known resin is able to be used. For example, a polycarbonate resin having a bisphenol A skeleton is used, and resins which are obtained by allowing a dihydroxy component to react with a carbonate precursor using an interfacial polymerization method or a melt polymerization method, and are disclosed, for example, in JP2006-277914A, JP2006-106386A, and JP2006-284703A are able to be preferably used. As a commercial product, “Tarflon MD1500” (manufactured by Idemitsu Kosan Co., Ltd.), and the like are able to be used.

Two or more thereof may be used, as necessary.

(Various Additives in First Protective Film)

Known additives, as necessary, may be mixed into the first protective film, and as an, example thereof, an ultraviolet absorbent, particles, a lubricant, an antiblocking agent, a thermal stabilizer, an antioxidant, an antistatic agent, a light resistant agent, an impact modifier, a dye, a pigment, and the like are included. However, in general, transparency is required for the first protective film, and thus it is preferable that the added amount of the additives is minimized.

—Ultraviolet Absorbent—

The first protective film is able to contain an ultraviolet absorbent in order to prevent the deterioration of the liquid crystal or the like of the liquid crystal display due to an ultraviolet ray. The ultraviolet absorbent is a compound having ultraviolet ray absorption performance, but is not particularly limited insofar as the ultraviolet absorbent is able to be resistant to heat which is added in a manufacturing step of the first protective film.

As the ultraviolet absorbent, an organic ultraviolet absorbent and an inorganic ultraviolet absorbent are included, and an organic ultraviolet absorbent is preferable from a viewpoint of transparency. The organic ultraviolet absorbent is not particularly limited, and as the organic ultraviolet absorbent, for example, a benzotriazole-based ultraviolet absorbent, a cyclic imino ester-based ultraviolet absorbent, a benzophenone-based ultraviolet absorbent, and the like are included. A benzotriazole-based ultraviolet absorbent and a cyclic imino ester-based ultraviolet absorbent are preferable from a viewpoint of durability. In addition, two or more types of the ultraviolet absorbent are able to be used in combination.

The benzotriazole-based ultraviolet absorbent is not limited to the following, and as the benzotriazole-based ultraviolet absorbent, for example, 2-[2′-hydroxy-5′-(methacryloyloxy methyl) phenyl]-2H-benzotriazole, 2-[2′-hydroxy-5′-(methacryloyloxy ethyl) phenyl]-2H-benzotriazole, 2-[2′-hydroxy-5′-(methacryloyloxy propyl) phenyl]-2H-benzotriazole, 2-[2′-hydroxy-5′-(methacryloyloxy hexyl) phenyl]-2H-benzo triazole, 2-[2′-hydroxy-3′-tert-butyl-5′-(methacryloyloxy ethyl) phenyl]-2H-benzotriazole, 2-[2′-hydroxy-5′-tert-butyl-3′-(methacryloyloxy ethyl) phenyl]-2H-benzotriazole, 2-[2′-hydroxy-5′-(methacryloyloxy ethyl) phenyl]-5-chloro-2H-benzotriazole, 2-[2′-hydroxy-5′-(methacryloyloxy ethyl) phenyl]-5-methoxy-2H-benzotriazole, 2-[2′-hydroxy-5′-(methacryloyloxy ethyl) phenyl]-5-cyano-2H-benzotriazole, 2-[2′-hydroxy-5′-(methacryloyloxy ethyl) phenyl]-5-tert-butyl-2H-benzotriazole, 2-[2′-hydroxy-5′-(methacryloyloxy ethyl) phenyl]-5-nitro-2H-benzotriazole, and the like are included.

In addition, as a commercial product, for example, the benzotriazole-based ultraviolet absorbent described above is able to be included, and as necessary, the benzotriazole-based ultraviolet absorbent is able to be used by being dispersed in water directly or through an emulsifier. In addition, as an aqueous benzotriazole-based ultraviolet absorbent, Newcoat UVA-204W (a trade name, manufactured by Shin-Nakamura Chemical Co., Ltd.), SE-2538E (a trade name, manufactured by Taisei Fine Chemical Co., Ltd.), and the like are able to be included.

The cyclic imino ester-based ultraviolet absorbent is not limited to the following, and as the cyclic imino ester-based ultraviolet absorbent, for example, 2-methyl-3,1-benzoxazine-4-one, 2-butyl-3,1-benzoxazine-4-one, 2-phenyl-3,1-benzoxazine-4-one, 2-(1- or 2-naphthyl)-3,1-benzoxazine-4-one, 2-(4-biphenyl)-3,1-benzoxazine-4-one, 2-p-nitrophenyl-3,1-benzoxazine-4-one, 2-m-nitrophenyl-3,1-benzoxazine-4-one, 2-p-benzoyl phenyl-3,1-benzoxazine-4-one, 2-p-methoxy phenyl-3,1-benzoxazine-4-one, 2-o-methoxy phenyl-3,1-benzoxazine-4-one, 2-cyclohexyl-3,1-benzoxazine-4-one, 2-p-(or m-)phthalimide phenyl-3,1-benzoxazine-4-one, N-phenyl-4-(3,1-benzoxazine-4-one-2-yl) phthalimide, N-benzoyl-4-(3,1-benzoxazine-4-one-2-yl) aniline, N-benzoyl-N-methyl-4-(3,1-benzoxazine-4-one-2-yl) aniline, 2-(p-(N-methyl carbonyl) phenyl))-3,1-benzoxazine-4-one, 2,2′-bis(3,1-benzoxazine-4-one), 2,2′-ethylene bis(3,1-benzoxazine-4-one), 2,2′-tetramethylene bis(3,1-benzoxazine-4-one), 2,2′-decamethylene bis(3,1-benzoxazine-4-one), 2,2′-(1,4-phenylene)bis[4H-3,1-benzoxazine-4-one] [furthermore, also referred to as 2,2′-p-phenylene bis (3,1-benzoxazine-4-one)], 2,2′-m-phenylene bis (3,1-benzoxazine-4-one), 2,2′-(4,4′-diphenylene)bis(3,1-benzoxazine-4-one), 2,2′-(2,6- or 1,5-naphthylene)bis(3,1-benzoxazine-4-one), 2,2′-(2-methyl-p-phenylene)bis(3,1-benzoxazine-4-one), 2,2′-(2-nitro-p-phenylene)bis(3,1-benzoxazine-4-one), 2,2′-(2-chloro-p-phenylene)bis(3,1-benzoxazine-4-one), 2,2′-(1,4-cyclohexylene)bis(3,1-benzoxazine-4-one), 1,3,5-tri(3,1-benzoxazine-4-one-2-yl) benzene, 1,3,5-tri(3,1-benzoxazine-4-one-2-yl) naphthalene, 2,4,6-tri(3,1-benzoxazine-4-one-2-yl) naphthalene, 2,8-dimethyl-4H,6H-benzo (1,2-d; 5,4-d)bis(1,3)-oxazine-4,6-dione, 2,7-dimethyl-4H,9H-benzo(1,2-d;4,5-d)bis(1,3)-oxazine-4,9-dione, 2,8-diphenyl-4H,8H-benzo(1,2-d;5,4-d)bis(1,3)-oxazine-4,6-dione, 2,7-diphenyl-4H,9H-benzo(1,2-d; 4,5-d′)bis(1,3)-oxazine-4,6-dione, 6,6′-bis(2-methyl-4H,3,1-benzoxazine-4-one), 6,6′-bis(2-ethyl-4H,3,1-benzoxazine-4-one), 6,6′-bis(2-phenyl-4H,3,1-benzoxazine-4-one), 6,6′-methylene bis(2-methyl-4H,3,1-benzoxazine-4-one), 6,6′-methylene bis(2-phenyl-4H,3,1-benzoxazine-4-one), 6,6′-ethylene bis(2-methyl-4H,3,1-benzoxazine-4-one), 6,6′-ethylene bis(2-phenyl-4H,3,1-benzoxazine-4-one), 6,6′-butylene bis(2-methyl-4H,3,1-benzoxazine-4-one), 6,6′-butylene bis(2-phenyl-4H,3,1-benzoxazine-4-one), 6,6′-oxy bis(2-methyl-4H,3,1-benzoxazine-4-one), 6,6′-oxy bis(2-phenyl-4H,3,1-benzoxazine-4-one), 6,6′-sulfonyl bis(2-methyl-4H,3,1-benzoxazine-4-one), 6,6′-sulfonyl bis(2-phenyl-4H,3,1-benzoxazine-4-one), 6,6′-carbonyl bis(2-methyl-4H,3,1-benzoxazine-4-one), 6,6′-carbonyl bis(2-phenyl-4H,3,1-benzoxazine-4-one), 7,7-methylene bis(2-methyl-4H,3,1-benzoxazine-4-one), 7,7′-methylene bis(2-phenyl-4H,3,1-benzoxazine-4-one), 7,7′-bis(2-methyl-4H,3,1-benzoxazine-4-one), 7,7′-ethylene bis(2-methyl-4H,3,1-benzoxazine-4-one), 7,7′-oxy bis(2-methyl-4H,3,1-benzoxazine-4-one), 7,7′-sulfonyl bis(2-methyl-4H,3,1-benzoxazine-4-one), 7,7′-carbonyl bis(2-methyl-4H,3,1-benzoxazine-4-one), 6,7′-bis(2-methyl-4H,3,1-benzoxazine-4-one), 6,7′-bis(2-phenyl-4H,3,1-benzoxazine-4-one), 6,7′-methylene bis(2-methyl-4H,3,1-benzoxazine-4-one), 6,7′-methylene bis(2-phenyl-4H,3,1-benzoxazine-4-one), and the like are included.

Among the compounds described above, in consideration of color tone, a benzoxazinone-based compound which is rarely tinted with yellow is preferably used, and as an example thereof, a compound denoted by General Formula (1) described below is more preferably used.

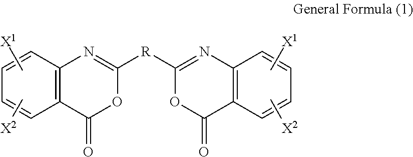

In General Formula (1) described above, R represents a bivalent aromatic hydrocarbon group, X¹ and X² are each independently selected from hydrogen or a group of the following functional groups, but are not necessarily limited thereto.

Group of Functional Groups: an alkyl group, an aryl group, a heteroaryl group, halogen, an alkoxyl group, an aryloxy group, a hydroxyl group, a carboxyl group, an ester group, and a nitro group.

In the present invention, among the compounds denoted by General Formula (1) described above, 2,2′-(1,4-phenylene)bis[4H-3,1-benzoxazine-4-one] is particularly preferable.

The content of the ultraviolet absorbent in the first protective film is generally less than or equal to 10.0 mass %, and is preferably in a range of 0.3 mass % to 3.0 mass %. When the content of the ultraviolet absorbent is greater than 10.0 mass %, the ultraviolet absorbent bleeds out onto the surface, and thus deterioration of surface functionality such as a decrease in adhesiveness may be caused.

In addition, when the first protective film has a multi-layer structure, it is preferable that the first protective film has at least three-layer structure, and it is preferable that the ultraviolet absorbent is mixed into an intermediate layer thereof. By mixing the ultraviolet absorbent into the intermediate layer, it is possible to prevent the compound from bleeding out onto the film surface, and as a result thereof, it is possible to maintain properties such as adhesiveness of the film.

(Properties of First Protective Film)

—Modulus of Elasticity—

The modulus of elasticity of the first protective film at 25° C. and relative humidity of 60% in the absorption axis direction of the polarizer (preferably, in a transporting direction of the first protective film, that is, the MD direction) is greater than or equal to 1.0 GPa and less than 4.0 GPa, is more preferably 1.1 GPa to 3.5 GPa, and is even more preferably 1.2 GPa to 3.0 GPa from a viewpoint of suppression of the curling of the polarization plate, and manufacturing suitability such as transporting properties at the time of preparing the film, slitting properties of an end portion, and resistance against rupturing.

Furthermore, when the modulus of elasticity of the first protective film at 25° C. and relative humidity of 60% in the absorption axis direction of the polarizer is less than the modulus of elasticity of the second protective film described below at 25° C. and relative humidity of 60% in the absorption axis direction of the polarizer, curling (MD minus curling) of the polarization plate easily occurs in the absorption axis direction of the polarizer (the MD direction) to the second protective film side in the polarization plate. According to the present invention, even when the modulus of elasticity of the first protective film at 25° C. and relative humidity of 60% in the absorption axis direction of the polarizer is less than the modulus of elasticity of the second protective film described below at 25° C. and relative humidity of 60% in the absorption axis direction of the polarizer, it is possible to suppress the curling of the polarization plate.

Here, the transporting direction of the film (the MD direction, and a longitudinal direction) is the transporting direction at the time of preparing the film (the MD direction), and a width direction is a direction orthogonal to the transporting direction at the time of preparing the film (a vertical direction, and the TD direction). It is preferable that the transporting direction of the first protective film (the MD direction, and the longitudinal direction) is parallel to the absorption axis of the polarizer in the polarization plate of the present invention. Furthermore, the expression “parallel” herein includes not only a completely parallel state but also a state of being shifted at an optically allowable degree of angle from the completely parallel state.

It is preferable that a vertical direction to the transporting direction of the first protective film (the TD direction) is the maximum direction of the in-plane modulus of elasticity of the first protective film. In the maximum direction of the in-plane modulus of elasticity of the protective film, the sound velocity of a film of which the humidity is conditioned in an atmosphere of 25° C. and relative humidity of 60% for 2 hours or more is measured in an atmosphere of 25° C. and relative humidity of 60% by dividing a 360-degree area into 32 sections using a sound velocity measurement device “SST-2501, manufactured by Nomura Shoji Co., Ltd.”, and thus a maximum speed direction is able to be determined as the maximum direction of the in-plane modulus of elasticity.

The modulus of elasticity of the film is able to be adjusted according to the type or the added amount of the thermoplastic resin which is the material of the first protective film, selection of the additives (in particular, the particle diameter, the refractive index, and the added amount of matting agent particles), and film manufacturing conditions (a stretching ratio and the like).

The modulus of elasticity was measured by preparing a sample having a length in the measurement direction of 200 mm and a width of 10 mm, by placing the sample in an environment of 60° C. and relative humidity of 90% for 48 hours, and then by setting the sample to be a shape having a width of 10 mm and a length between chucks of 100 mm using Strograph V10-C manufactured by Toyo Seiki Kogyo Co., Ltd. immediately after placing the sample in an environment of 25° C. and relative humidity of 60% for 48 hours.

Furthermore, even when the polarizer adheres to any one or both of the first protective film and the second protective film, polyvinyl alcohol which is the polarizer is softened and removed by being dipped in hot water or the like, and thus it is possible to measure the modulus of elasticity of a single film.

The ratio of the modulus of elasticity of the first protective film at 25° C. and relative humidity of 60% in the absorption axis direction of the polarizer to the modulus of elasticity of the first protective film at 25° C. and relative humidity of 60% in the direction orthogonal to the absorption axis of the polarizer (hereinafter, also referred to as an MD/TD modulus of elasticity ratio of the modulus of elasticity) is less than or equal to 0.8, and is preferably 0.01 to 0.8. In addition, the ratio is further preferably 0.01 to 0.7, and is particularly preferably 0.01 to 0.6.

—Phase Difference—

In the first protective film, retardation Re (a phase difference value) in an in-plane direction is preferably greater than or equal to 3000 nm, is more preferably 3000 nm to 30000 nm, is particularly preferably 4000 nm to 20000 nm, and is even more preferably greater than or equal to 6000 nm and less than or equal to 15000 nm. By setting an in-plane phase difference value to be greater than or equal to 3000 nm, rainbow-like unevenness tends to be rarely visible at the time of incorporating the polarization plate of the present invention into a liquid crystal display device. By setting the in-plane phase difference value to be less than or equal to 30000 nm, the film is able to be thinned and to have excellent brittleness resistance and handleability.

Rainbow-like unevenness occurs when light incident on a polarization plate including a polymer film having large birefringence, specifically, Re of greater than or equal to 500 nm and less than 3000 nm as a protective film from a backlight light source in an oblique direction is observed from a visible side, and in particular, the rainbow-like unevenness becomes remarkable in a liquid crystal display device in which, for example, a light source such as a cold cathode tube including a bright line spectrum is used as a backlight.

Here, when a white light source including a continuous emission spectrum is used as a backlight light source, Re of the first protective film is in the range described above, and the rainbow-like unevenness is rarely visible, and thus setting Re of the first protective film to be in the range described above is preferable.

The rainbow-like unevenness is also able to be reduced by setting an Nz value indicating a relationship between Re and Rth to a suitable value, and the absolute value of the Nz value is preferably less than or equal to 2.0, is more preferably 0.5 to 2.0, and is even more preferably 0.5 to 1.5, from a viewpoint of an effect of reducing the rainbow-like unevenness and manufacturing suitability.

The rainbow-like unevenness occurs due to incident light, and thus is generally observed at the time of white display.

Furthermore, the in-plane phase difference value Re of the first protective film is denoted by Expression (4) described below.

Re=(nx−ny)×y₁ (4)

Here, nx represents the refractive index of the first protective film in an in-plane slow axis direction, ny represents the refractive index of the first protective film in an in-plane fast axis direction (a direction orthogonal to the in-plane slow axis direction), and y₁ represents the thickness of the first protective film.

Retardation Rth of the first protective film in a thickness direction is denoted by Expression (5) described below.

Rth={(nx+ny)/2−nz}×y₁ (5)

Here, nz represents the refractive index of the first protective film in the thickness direction.

In addition, it is preferable that the Nz value of the first protective film is less than or equal to 2.0. Furthermore, the Nz value of the first protective film is denoted by Expression (6) described below.

Nz=(nx−nz)/(nx−ny) (6)

Herein, Re, Rth, and Nz at a wavelength of λ nm are able to be measured as follows.

An alignment axis direction of the first protective film was obtained by using two polarization plates, and the first protective film was cut into the shape of a rectangle of 4 cm×2 cm such that the alignment axes were orthogonal to each other, and thus a sample for measurement was obtained. The orthogonal biaxial refractive indexes (Nx, Ny), and the refractive index (Nz) in the thickness direction of this sample were obtained by using an Abbe's refractometer (NAR-4T, measurement wavelength of 589 nm, manufactured by Atago Co., Ltd.), the absolute value of the biaxial refractive index difference (|Nx−Ny|) was set to the anisotropy of the refractive index (ΔNxy). The thickness y₁ (nm) of the first protective film was measured by using an electric micrometer (Miritoron 1245D, manufactured by Fine Liu full Ltd), and the unit was converted into nm Re, Rth, and Nz were respectively calculated from the values of the measured Nx, Ny, Nz, and y₁.

Re and Rth described above are able to be adjusted according to the type of the thermoplastic resin to be used in the film, the amount of the thermoplastic resin and the additives, addition of a retardation increasing agent, the film thickness of the film, a stretching direction and a stretching ratio of the film, and the like.

—Film Thickness—

The thickness of the first protective film is preferably 10 μm to 200 μm, is ore preferably 15 μm to 100 μm, and is particularly preferably 20 μm to 80 μm. When the thickness of the first protective film is greater than or equal to 10 μm, the handling tends to be easy, and when the thickness is less than or equal to 200 μm, manufacturing costs tend to be reduced due to thinning.

(Manufacturing Method of First Protective Film)

It is preferable that the first protective film described above is stretched in the width direction from a viewpoint of expressing the phase difference value. The manufacturing method of the first protective film is not particularly limited. In order to apply the properties described above to the first protective film described above, it is preferable that the first protective film is manufactured by using the following method.

It is preferable that, first, a resin used in the first protective film (for example, a polyester resin) is melted and extruded into the shape of a film, and is cooled and solidified by a casting drum to be a unstretched film, and then, as necessary, a coating liquid for forming an easily adhesive layer is applied onto the unstretched film, and the unstretched film is stretched at a stretching ratio of 3 times to 10 times, and preferably at a stretching ratio of 3 times to 7 times at a temperature of Tg of the polyester film to (Tg+60°) C. in the width direction. It is preferable that the first protective film is monoaxially stretched in the width direction from a viewpoint of largely expressing the retardation Re in the in-plane direction.

Next, it is preferable that a heat treatment (here, referred to as thermal fixation) is performed at a temperature of higher than or equal to 140° C. and lower than or equal to 220° C. for 1 second to 60 seconds. The thermal fixation temperature is preferably higher than or equal to 150° C. and lower than or equal to 220° C., and is particularly preferably higher than or equal to 150° C. and lower than 220° C.

Further, it is preferable that the first protective film is subjected to the heat treatment (referred to as a relaxation treatment) again at a temperature 10° C. to 20° C. lower than the thermal fixation temperature while performing contraction in the longitudinal direction or/and the width direction at a ratio of 0% to 20%. In this method, the film is less likely to be in contact with a roll, and thus fine scratches or the like are rarely generated on the film surface compared to the methods described above, and this method is advantageous to be applied to optical usage. Furthermore, the glass transition temperature of the film is denoted by Tg. When the thermal fixation temperature is higher than or equal to 150° C. and lower than 220° C., a shift in an alignment direction of polyester decreases, and a thermal dimensional change decreases, and thus a hard coat layer is rarely peeled off or cracked.

<Second Protective Film>

The polarization plate of the present invention includes the second protective film bonded to the other surface of the polarizer from the side to which the first protective film is bonded through the adhesive layer 2, in which the modulus of elasticity of the second protective film at 25° C. and relative humidity of 60 in the absorption axis direction of the polarizer is greater than or equal to 2.0 GPa and less than 5.0 GPa, and the second protective film satisfies (Expression 1) and (Expression 2) described below.

d2/d1≦0.8 (Expression 1)

d2≦40 μm (Expression 2)

(In Expression 1 and Expression 2, d1 represents the thickness of the first protective film (unit: μm), and d2 represents the thickness of the second protective film (unit: μm).)

(Resin)

A main component of the second protective film is not particularly limited, and as the main component, a thermoplastic resin such as a cycloolefin resin, an acrylic resin, or a cellulose-based resin is able to be included, and in the polarization plate of the present invention, it is preferable that the second protective film contains a cellulose-based resin as a main component.

It is preferable that the second protective film is a film containing a resin such as a cellulose-based resin as a main component, and the second protective film may be a single layer film containing a resin such as a cellulose-based resin as a main component or may be a multi-layer film including a layer containing a resin such as a cellulose-based resin as a main component. In addition, both surfaces or one surface of the single layer film or the multi-layer film may be subjected to a surface treatment, and this surface treatment may be surface modification using a corona treatment, a saponification treatment, a heat treatment, ultraviolet irradiation, electron beam irradiation, and the like, or may be thin film formation using coating or deposition of a polymer, metal, or the like. The mass ratio of a resin such as a cellulose-based resin with respect to the total mass of the film is generally greater than or equal to 50 mass %, is preferably greater than or equal to 70 mass %, is more preferably greater than or equal to 90 mass %.

—Cellulose-Based Resin—

Hereinafter, the cellulose-based resin (preferably cellulose acylate) used in the second protective film will be described in detail.

The degree of substitution of the cellulose acylate indicates a ratio in which three hydroxyl groups existing in a constituent unit of cellulose (glucose having (β)1,4-glycoside bond) are acylated. The degree of substitution (the degree of acylation) is able to be calculated by measuring the amount of a bonded fatty acid per a constituent unit mass of cellulose. In the present invention, the degree of substitution of the cellulose is able to be calculated by dissolving the cellulose in a solvent of deuterium substituted dimethyl sulfoxide or the like, by measuring a 13C-NMR spectrum, and by obtaining the degree of substitution from a peak intensity ratio of carbonyl carbon in an acyl group. The degree of substitution is able to be obtained by substituting a residual hydroxyl group of the cellulose acylate with other acyl groups which are different from the acyl group contained in the cellulose acylate itself, and then by being subjected to 13C-NMR measurement. The details of a measurement method are disclosed in TEZUKA et al., (Carbohydrate. Res., 273 (1995) 83-91).

The total degree of acyl substitution of the cellulose acylate is preferably 2.0 to 2.97, is more preferably 2.2 to 2.95, and is particularly preferably 2.3 to 2.95.

As the acyl group of the cellulose acylate, an acetyl group, a propionyl group, and a butyryl group are preferable, and an acetyl group, and a propionyl group are more preferable.

Among them, in the polarization plate of the present invention, it is preferable that cellulose acylate having a low degree of substitution (DAC) in which the degree of substitution of an acyl group of a cellulose-based resin contained in the second protective film is greater than or equal to 2.0 and less than 2.6, or cellulose acylate having a high degree of substitution (TAC) in which the total degree of acyl substitution is 2.6 to 2.97 is used, and it is particularly preferable that the cellulose acylate having a low degree of substitution (DAC) in which the degree of substitution of the acyl group of the cellulose-based resin is greater than or equal to 2.0 and less than 2.6 from a viewpoint of further suppressing unevenness of a front surface at the time of incorporating the polarization plate to be obtained in the liquid crystal display device. It is assumed that this is because the photo elasticity of the film decreases.

Mixed fatty acid ester formed of two or more types of the acyl groups is also able to be preferably used as the cellulose acylate in the present invention. Even in this case, as the acyl group, an acetyl group and an acyl group having 3 to 4 carbon atoms are preferable. In addition, when the mixed fatty acid ester is used, the degree of substitution of the acetyl group is preferably less than 2.5, and is more preferably less than 1.9. On the other hand, the degree of substitution of the acyl group having 3 to 4 carbon atoms is preferably 0.1 to 1.5, is more preferably 0.2 to 1.2, and is particularly preferably 0.5 to 1.1. Among them, it is preferable that cellulose acylate propionate (CAP) is used in the present invention from a viewpoint of increasing the modulus of elasticity under high temperature and high humidity and of suppressing the curling of the polarization plate.

In the present invention, two types of the cellulose acylates having different substituent groups and/or different degrees of substitution may be used in combination or may be used by being mixed, and a film including a plurality of layers formed of different cellulose acylates may be formed according to a cocasting method or the like described below.

Further, mixed acid ester having a fatty acid acyl group and a substituted or non-substituted aromatic acyl group which is disclosed in paragraph numbers “0023” to “0038” of JP2008-20896A is able to be preferably used in the present invention.

The mass average degree of polymerization of the cellulose acylate is preferably 250 to 800, and is more preferably 300 to 600.

In addition, the number average molecular weight of the cellulose acylate is preferably 70000 to 230000, is more preferably 75000 to 230000, and is most preferably 78000 to 120000.

The cellulose acylate is able to be synthesized by using an acid anhydride or an acid chloride as an acylation agent. When the acylation agent is an acid anhydride, an organic acid (for example, an acetic acid) or a methylene chloride is used as a reaction solvent. In addition, a protonic catalyst such as a sulfuric acid is able to be used as a catalyst. When the acylation agent is an acid chloride, a basic compound is able to be used as a catalyst. In a synthesis method which is most prevalent in the industry, cellulose is esterified with a mixed organic acid component containing an organic acid corresponding to an acetyl group and other acyl groups (an acetic acid, a propionic acid, and a butyric acid), or an acid anhydride thereof (an acetic acid anhydride, an propionic acid anhydride, and a butyric acid anhydride), and thus the cellulose ester is synthesized.

In the method described above, in general, cellulose such as cotton linter or wood pulp is subjected to an activation treatment with an organic acid such as an acetic acid, and then the cellulose is esterified by using a mixed liquid of an organic acid component as described above in the presence of a sulfuric acid catalyst. In general, an organic acid anhydride component is used in an excess amount with respect to the amount of a hydroxyl group in the cellulose. In this esterification treatment, a hydrolysis reaction of a cellulose main chain (a (β)1,4-glycoside bond) (a depolymerization reaction) progresses in addition to the esterification reaction. When the hydrolysis reaction of the main chain progresses, the degree of polymerization of the cellulose ester decreases, and the physical properties of a cellulose ester film to be manufactured decrease. For this reason, it is preferable that reaction conditions such as a reaction temperature are determined in consideration of the degree of polymerization or the molecular weight of cellulose ester to be obtained.

(Various Additives of Second Protective Film)

The second protective film may contain an organic acid or known additives used in other polarization plate protective films, unless they are contrary to the gist of the present invention. The molecular weight of the additive is not particularly limited, and the following additives are able to be preferably used.

By adding the additive, a useful effect is obtained from a viewpoint of control of the rate of a humidity dimensional change, improvement of the thermal properties, the optical properties, and the mechanical properties of the film, and film modification such as application of flexibility, application of water absorption resistance, and a reduction in moisture permeability.

For example, as the control of the mechanical properties, addition of a plasticizer to the film is included, as an example of the plasticizer for reference, various known ester-based plasticizers such as phosphoric acid ester, citric acid ester, trimellitic acid ester, and sugar ester or a polyester-based polymer disclosed in paragraph numbers “0042” to “0068” of WO2011/102492A are able to be included.

In addition, as the control of the optical properties, application of ultraviolet ray or infrared ray absorption performance is able to refer to the disclosure of paragraph numbers “0069” to “0072” of WO2011/102492, and in order to adjust the phase difference of the film or to control the development properties, a known retardation conditioner is able to be used. The molecular weight of the additive is not particularly limited, and the following additives are able to be preferably used.

(Properties of Second Protective Film)

—Modulus of Elasticity—

The modulus of elasticity of the second protective film at 25° C. and relative humidity of 60% in the absorption axis direction of the polarizer (the MD direction) is greater than or equal to 2.0 GPa and less than 5.0 GPa. When the modulus of elasticity of the second protective film in the MD direction is less than 5.0 GPa, the optical properties are sufficiently expressed, and when the modulus of elasticity of the second protective film in the MD direction is greater than or equal to 2.0 GPa, the occurrence of curling is able to be sufficiently suppressed.

The modulus of elasticity of the second protective film at 25° C. and relative humidity of 60% in the absorption axis direction of the polarizer (the MD direction) is more preferably greater than or equal to 3.0 GPa and less than 5.0 GPa, and is particularly preferably 3.2 GPa to 4.2 GPa, from a viewpoint of the suppression of the curling of the polarization plate, and manufacturing suitability such as transporting properties at the time of preparing the film, slitting properties of an end portion, and resistance against rupturing.

It is preferable that the transporting direction of the second protective film (the MD direction, and the longitudinal direction) is parallel to the absorption axis of the polarizer in the polarization plate of the present invention.

In the polarization plate of the present invention, the ratio of the modulus of elasticity of the second protective film at 25° C. and relative humidity of 60% in the absorption axis direction of the polarizer to the modulus of elasticity of the second protective film at 25° C. and relative humidity of 60% in the direction orthogonal to the absorption axis of the polarizer is preferably greater than or equal to 0.6 and less than to 1.1, is more preferably greater than or equal to 0.6 and less than 1.0, and is particularly preferably greater than or equal to 0.65 and less than 0.9, from a viewpoint of suppressing the curling (the MD minus curling) of the polarization plate in the absorption axis direction of the polarizer (the MD direction) to the second protective film side by having a contraction balance between the first protective film and the second protective film.

The modulus of elasticity of the second protective film which is used as a material for manufacturing the polarization plate of the present invention at 70° C. and relative humidity of 60% in the absorption axis direction of the polarizer (the MD direction) is preferably 1.5 GPa to 3.0 GPa, is more preferably 1.6 GPa to 2.5 GPa, and is particularly preferably 1.8 GPa to 2.3 GPa, from a viewpoint of suppressing the curling (the MD minus curling) of the polarization plate in the absorption axis direction of the polarizer (the MD direction) to the second protective film side by having a contraction balance between the first protective film and the second protective film.

—Film Thickness—

In the polarization plate of the present invention, the thickness d2 of the second protective film satisfies (Expression 2) described below.

d2≦40 μm (Expression 2)

(In Expression 2, d2 represents the thickness of the second protective film (unit: μm).)

The thickness d2 of the second protective film is preferably 10 μm to 40 μm, is more preferably 15 μm to 40 μm, and is particularly preferably 20 μm to 40 μm. When the thickness of the second protective film is greater than or equal to 10 μm, handling tends to be easy, and when the thickness is less than or equal to 40 μm, curling of a polarization plate to be obtained is able to be sufficiently suppressed, and manufacturing costs tend to be reduced due to thinning.

By thinning the thickness of the second protective film, it is possible to decrease the contractile force of the polarization plate in the absorption axis direction of the polarizer (the MD direction) to the second protective film side, and thus the occurrence of the curling (the MD minus curling) of the polarization plate is easily suppressed.

(Film Thickness Ratio between First Protective Film and Second Protective Film)

In the polarization plate of the present invention, a film thickness ratio between the second protective film and the first protective film satisfies (Expression 1) described below.

d2/d1≦0.8 (Expression 1)

(In Expression 1, d1 represents the thickness of the first protective film (unit: μm), and d2 represents the thickness of the second protective film (unit: μm).)

By satisfying (Expression 1) described above, it is possible to suppress the curling of the polarization plate. By setting the thickness of the second protective film to be thinner than the thickness of the first protective film at a certain ratio or more, it is possible to decrease the contractile force of the polarization plate in the absorption axis direction of the polarizer (the MD direction) to the second protective film side, and thus the occurrence of the curling (the MD minus curling) of the polarization plate is easily suppressed.

The film thickness ratio between the second protective film and the first protective film is preferably d2/d1≦0.7, and is more preferably d2/d1≦0.6.

The lower limit value of the film thickness ratio d2/d1 between the second protective film and the first protective film is not particularly limited, and for example, is preferably greater than or equal to 0.1, and is more preferably greater than or equal to 0.2.

<Adhesive Layer>

In the polarization plate of the present invention, the polarizer is bonded to the first protective film through the adhesive layer 1, and the polarizer is bonded to the second protective film through the adhesive layer 2. It is preferable that the adhesive layer 1 and the adhesive layer 2 contain a curable adhesive agent.

In general, a polarizer side easily adhesive layer is disposed on the first protective film on the polarizer side, and the polarizer is bonded thereon through the adhesive agent for the adhesion of the polarizer.

As the adhesive agent, known adhesive agents of the related art are able to be used, and for example, an acrylic compound such as polyvinyl alcohol, polyvinyl butyral, and polybutyl acrylate, an epoxy-based compound having an alicyclic epoxy group which is exemplified as a glycidyl group or epoxy cyclohexane, and the like are included. Among them, in the polarization plate of the present invention, a main component of the adhesive layer 1 and the adhesive layer 2 is preferably an aqueous adhesive agent (the adhesive layer 1 and the adhesive layer 2 are layers formed by curing an aqueous adhesive agent), is more preferably polyvinyl alcohol, and polyvinyl butyral, and is particularly preferably polyvinyl alcohol.

<Easily Adhesive Layer>

In the polarization plate of the present invention, it is preferable that an adhesive layer is used as the easily adhesive layer for adhering to other members. For example, in order to improve adhesiveness between the polarizer and the first protective film, the polarizer side easily adhesive layer is able to be used as a base substrate of the adhesive layer 1 on the surface of the first protective film on which the polarizer is disposed.

(Polarizer Side Easily Adhesive Layer)

The polarizer side easily adhesive layer of the present invention is a layer for improving the adhesiveness with respect to various functional layers, and for example, is able to be used for improving the adhesiveness with respect to the various adhesive layers which are used for bonding the polarizer to the polyester film.

In order to improve the adhesiveness between the polyester film and the adhesive layer, a compound such as a urethane resin and polyvinyl alcohol was considered. Further, as a result of continuous consideration, it was found that the adhesiveness was comparatively improved in the easily adhesive layer faulted by combining the urethane resin and the polyvinyl alcohol. On the other hand, as a result of various considerations of a crosslinking agent, it was also found that the adhesiveness was comparatively improved by combining an oxazoline compound and polyvinyl alcohol or an oxazoline compound and a urethane resin, and by studying the composition ratio thereof. By summarizing these results, the urethane resin, the polyvinyl alcohol, and the oxazoline compound were used in combination, and thus the adhesiveness was unexpectedly considerably improved, and the easily adhesive layer which was able to be used for protecting the polarizer was successfully formed.

As the urethane resin contained in the polarizer side easily adhesive layer of the present invention is a polymer compound having a urethane resin in the molecule. In general, the urethane resin is prepared by allowing polyol to react with isocyanate. As the polyol, polycarbonate polyols, polyester polyols, polyether polyols, polyolefin polyols, and acryl polyols are included, and these compounds may be independently used, or a plurality of types thereof may be used.

The polycarbonate polyols are obtained by performing a dealcoholization reaction from polyhydric alcohols and a carbonate compound. As the polyhydric alcohols, ethylene glycol, 1,2-propylene glycol, 1,3-propylene glycol, 1,2-butane diol, 1,3-butane diol, 1,4-butane diol, 1,5-pentane diol, 1,6-hexane diol, 1,4-cyclohexane diol, 1,4-cyclohexane dimethanol, 1,7-heptane diol, 1,8-octane diol, 1,9-nonane diol, 1,10-decane diol, neopentyl glycol, 3-methyl-1,5-pentane diol, 3,3-dimethylol heptane, and the like are included. As the carbonate compound, dimethyl carbonate, diethyl carbonate, diphenyl carbonate, ethylene carbonate, and the like are included, and as polycarbonate-based polyols which are obtained from the reaction, for example, poly(1,6-hexylene) carbonate, poly(3-methyl-1,5-pentylene) carbonate, and the like are included.

As the polyester polyols, polyester polyols obtained from a reaction of a polyvalent carboxylic acid (a malonic acid, a succinic acid, a glutaric acid, an adipic acid, a pimelic acid, a suberic acid, a sebacic acid, a fumaric acid, a maleic acid, a terephthalic acid, an isophthalic acid, and the like) or an acid anhydride thereof, and polyhydric alcohol (ethylene glycol, diethylene glycol, triethylene glycol, propylene glycol, dipropylene glycol, tripropylene glycol, butane diol, 1,3-butane diol, 1,4-butane diol, 2,3-butane diol, 2-methyl-1,3-propane diol, 1,5-pentane diol, neopentyl glycol, 1,6-hexane diol, 3-methyl-1,5-pentane diol, 2-methyl-2,4-pentane diol, 2-methyl-2-propyl-1,3-propane diol, 1,8-octane diol, 2,2,4-trimethyl-1,3-pentane diol, 2-ethyl-1,3-hexane diol, 2,5-dimethyl-2,5-hexane diol, 1,9-nonane diol, 2-methyl-1,8-octane diol, 2-butyl-2-ethyl-1,3-propane diol, 2-butyl-2-hexyl-1,3-propane diol, cyclohexane diol, bishydroxy methyl cyclohexane, dimethanol benzene, bishydroxy ethoxy benzene, alkyl dialkanol amine, lactone diol, and the like) are included.

As the polyether polyols, polyethylene glycol, polypropylene glycol, polyethylene propylene glycol, polytetramethylene ether glycol, polyhexamethylene ether glycol, and the like are included.

Among the polyols described above, in order to improve the adhesiveness with respect to various adhesive layers, the polycarbonate polyols are more preferably used.

As the polyisocyanate compound used for obtaining the urethane resin, aromatic diisocyanate such as tolylene diisocyanate, xylylene diisocyanate, methylene diphenyl diisocyanate, phenylene diisocyanate, naphthalene diisocyanate, and tolidine diisocyanate, aliphatic diisocyanate having an aromatic ring such as α,α,α′,α′-tetramethyl xylylene diisocyanate, aliphatic diisocyanate such as methylene diisocyanate, propylene diisocyanate, lysine diisocyanate, trimethyl hexamethylene diisocyanate, and hexamethylene diisocyanate, alicyclic diisocyanate such as cyclohexane diisocyanate, methyl cyclohexane diisocyanate, isophorone diisocyanate, dicyclohexyl methane diisocyanate, and isopropylidene dicyclohexyl diisocyanate, and the like are exemplified. These compounds may be independently used, or a plurality of types thereof may be used in combination.

When the urethane resin is synthesized, a chain extender may be used, and the chain extender is not particularly limited insofar as the chain extender has two or more active groups which are able to react with an isocyanate group, and as the chain extender, in general, a chain extender having two or more hydroxyl groups or amino groups is able to be mainly used.

As the chain extender having two or more hydroxyl groups, for example, glycols such as aliphatic glycol such as ethylene glycol, propylene glycol, butane diol, aromatic glycol such as xylylene glycol, and bishydroxy ethoxy benzene, ester glycol such as neopentyl glycol hydroxy pivalate are able to be included. In addition, as the chain extender having two or more amino groups, for example, aromatic diamine such as tolylene diamine, xylylene diamine, and diphenyl methane diamine, aliphatic diamine such as ethylene diamine, propylene diamine, hexane diamine, 2,2-dimethyl-1,3-propane diamine, 2-methyl-1,5-pentane diamine, trimethyl hexane diamine, 2-butyl-2-ethyl-1,5-pentane diamine, 1,8-octane diamine, 1,9-nonane diamine, and 1,10-decane diamine, alicyclic diamine such as 1-amino-3-aminomethyl-3,5,5-trimethyl cyclohexane, dicyclohexyl methane diamine, isopropylidene cyclohexyl-4,4′-diamine, 1,4-diaminocyclohexane, and 1,3-bisaminomethyl cyclohexane, and the like are included.

In the urethane resin of the present invention, a solvent may be used as a medium, and preferably, water is used as a medium. In order to disperse or dissolve the urethane resin in water, forced emulsification using an emulsifier, self-emulsification by introducing a hydrophilic group into the urethane resin, or water solubilization, and the like are used. In particular, the self-emulsification in which an ion group is introduced into the skeleton of the urethane resin and is ionomerized is preferable from a viewpoint of excellent storage stability of the liquid or excellent waterproofness, transparency, and adhesiveness of the easily adhesive layer to be obtained. In addition, as the ion group to be introduced, various ion groups such as a carboxyl group, a sulfonic acid, a phosphoric acid, a phosphonic acid, and a quaternary ammonium salt are included, and a carboxyl group is preferable. As method of introducing the carboxyl group to the urethane resin, various methods are able to be used in each step of a polymerization reaction. For example, when a prepolymer is synthesized, a method of using a resin having a carboxyl group as a copolymerization component, a method of using a component having a carboxyl group as one component such as polyol or polyisocyanate, and a chain extender are used. In particular, a method of introducing a desired amount of carboxyl groups by using carboxyl group-containing diol according to the charged amount of the component is preferable. For example, a dimethylol propionic acid, a dimethylol butanoic acid, a bis-(2-hydroxy ethyl) propionic acid, a bis-(2-hydroxy ethyl) butanoic acid, and the like are able to be copolymerized with respect to diol used for polymerizing the urethane resin. In addition, it is preferable that the carboxyl group is in the form of a neutralized salt such as ammonia, amine, alkali metals, and inorganic alkalies. In particular, ammonia, trimethyl amine, and triethyl amine are preferable. Such a urethane resin is able to use a carboxyl group, excluding a neutralizing agent in a drying step after coating, as a crosslinking reaction point of other crosslinking agents. Accordingly, stability in a liquid state before the coating becomes excellent, durability, solvent resistance, waterproofness, and blocking resistance of the easily adhesive layer to be obtained, and the like are able to be further improved.

In the present invention, the polyvinyl alcohol contained in the polarizer side easily adhesive layer has a polyvinyl alcohol portion, and for example, includes a modified compound in which the polyvinyl alcohol is partially acetalized or butyralized, and thus known polyvinyl alcohol of the related art is able to be used. The degree of polymerization of the polyvinyl alcohol is not particularly limited, and polyvinyl alcohol of which the degree of polymerization is generally greater than or equal to 100, and is preferably in a range of 300 to 40000 is used. When the degree of polymerization is less than 100, the waterproofness of the easily adhesive layer may decrease. In addition, the degree of saponification of the polyvinyl alcohol is not particularly limited, and a polyacetic acid vinyl saponification product of which the degree of saponification is greater than or equal to 70 mol %, and is preferably in a range of 70 mol % to 99.9 mol % is practically used.

In the present invention, the oxazoline compound contained in the polarizer side easily adhesive layer is a compound having an oxazoline group in the molecule. In particular, the oxazoline compound is preferably a polymer having an oxazoline group, and is able to be prepared by polymerizing an addition polymerizable oxazoline group-containing monomer independently or with other monomers. As the addition polymerizable oxazoline group-containing monomer, 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-5-ethyl-2-oxazoline, and the like are able to be included, and one type of the monomers or a mixture of two or more types thereof is able to be used. Among them, 2-isopropenyl-2-oxazoline is industrially readily available and is preferable. The other monomer is not limited insofar as the monomer is able to be copolymerized with the addition polymerizable oxazoline group-containing monomer, and as the other monomer, for example, (meth)acrylic acid esters such as alkyl (meth)acrylate (as an alkyl group, a methyl group, an ethyl group, an n-propyl group, an isopropyl group, an n-butyl group, an isobutyl group, a t-butyl group, a 2-ethyl hexyl group, and a cyclohexyl group); unsaturated carboxylic acids such as an acrylic acid, a methacrylic acid, an itaconic acid, a maleic acid, a fumaric acid, a crotonic acid, a styrene sulfonic acid, and a salt thereof (a sodium salt, a potassium salt, an ammonium salt, a tertiary amine salt, and the like); unsaturated nitriles such as acrylonitrile and methacrylonitrile; unsaturated amides such as (meth)acrylamide, N-alkyl (meth)acrylamide, and N,N-dialkyl (meth)acrylamide, (as an alkyl group, a methyl group, an ethyl group, an n-propyl group, an isopropyl group, an n-butyl group, an isobutyl group, a t-butyl group, a 2-ethyl hexyl group, a cyclohexyl group, and the like); vinyl esters such as vinyl acetate, and vinyl propionate; vinyl ethers such as methyl vinyl ether and ethyl vinyl ether; α-olefins such as ethylene and propylene; halogen-containing α,β-unsaturated monomers such as vinyl chloride, vinylidene chloride, and vinyl chloride; an α,β-unsaturated aromatic monomers such as styrene and α-methyl styrene, and the like are able to be included, and one type or two or more types thereof are able to be used.

In addition, a monomer having a small amount of hydrophilic groups such as a polyalkylene glycol component and a large amount of oxazoline groups is able to be expected to improve the strength of a coated film and wet heat resistance.

The content of a compound derived from the urethane resin in the polarizer side easily adhesive layer is generally 10 mass % to 80 mass %, preferably 15 mass % to 75 mass %, and is more preferably 20 mass % to 50 mass %. When the amount of the urethane resin is outside of the range described above, an adhesive force between the polyester film and the adhesive layer may not be sufficiently obtained.

The content of a compound derived from the polyvinyl alcohol in the polarizer side easily adhesive layer is generally 10 mass % to 80 mass %, is preferably 15 mass % to 60 mass %, and is more preferably 20 mass % to 50 mass %. When the content is less than 10 mass %, a polyvinyl alcohol component decreases, and thus the adhesiveness with respect to the adhesive layer may not be sufficient, and when the content is greater than 80 mass %, other components decrease, and thus the adhesiveness with respect to the polyester film may not be sufficient.

The content of a compound derived from the oxazoline compound in the polarizer side easily adhesive layer is generally 10 mass % to 80 mass %, is preferably 15 mass % to 60 mass %, and is more preferably 20 mass % to 40 mass %. When the content is less than 10 mass %, a crosslinking component decreases, and thus the easily adhesive layer is easily broken, and the wet heat resistance may decrease, and when the content is greater than 80 mass %, the other component decreases, and thus the adhesiveness with respect to the polyester film or the adhesiveness with respect to the adhesive layer may not be sufficient.

In the polarizer side easily adhesive layer, a binder polymer is able to be used in combination in addition to the polyester resin or the polyvinyl alcohol in order to improve the shape of a coated surface or the transparency.

In the present invention, the “binder polymer” is defined as a binder polymer which is a polymer compound having a number average molecular weight (Mn) of greater than or equal to 1000 according to gel permeation chromatography (GPC) measurement, and has film formability on the basis of a polymer compound safety evaluation flow scheme (sponsored by Chemical Substances Council in November, 1985).

As a specific example of the binder polymer, a polyester resin, an acrylic resin, a polyvinyl (polyvinyl chloride, a vinyl chloride-vinyl acetate copolymer, and the like), polyalkylene glycol, polyalkylene imine, methyl cellulose, hydroxy cellulose, starches, and the like are included.

Further, in the polarizer side easily adhesive layer, a crosslinking agent is able to be used in combination in addition to the oxazoline compound within a range not impairing the gist of the present invention. As the crosslinking agent, various known resins are able to be used, and for example, a melamine compound, an epoxy compound, an isocyanate compound, a carbodiimide compound, and the like are included.

As the melamine compound, a compound having a melamine skeleton in the compound is included. For example, an alkylolated melamine derivative, a compound in which an alkylolated melamine derivative is partially or completely etherified by reacting with alcohol, and a mixture thereof are able to be used. As the alcohol used in the etherification, methyl alcohol, ethyl alcohol, isopropyl alcohol, n-butanol, isobutanol, and the like are preferably used. In addition, as the melamine compound, either a monomer or a dimer or more, such as a multimer may be used, or a mixture thereof may be used. Further, a melamine compound in which urea or the like is cocondensed into a part of melamine is also able to be used, and a catalyst is also able to be used in order to increase the reactivity of the melamine compound.

As the epoxy compound, for example, a compound having an epoxy group in the molecule, and a prepolymer and a cured product thereof are included. For example, a condensate of epichlorohydrin and a hydroxyl group such as ethylene glycol, polyethylene glycol, glycerin, polyglycerin, and bisphenol A or an amino group is included, and as the condensate, a polyepoxy compound, a diepoxy compound, a monoepoxy compound, a glycidyl amine compound, and the like are included. As the polyepoxy compound, for example, sorbitol, polyglycidyl ether, polyglycerol polyglycidyl ether, pentaerythritol polyglycidyl ether, diglycerol polyglycidyl ether, triglycidyl tris(2-hydroxy ethyl) isocyanate, glycerol polyglycidyl ether, and trimethylol propane polyglycidyl ether are included, as the diepoxy compound, for example, neopentyl glycol diglycidyl ether, 1,6-hexane diol diglycidyl ether, resorcin diglycidyl ether, ethylene glycol diglycidyl ether, polyethylene glycol diglycidyl ether, propylene glycol diglycidyl ether, polypropylene glycol diglycidyl ether, and polytetramethylene glycol diglycidyl ether are included, as the monoepoxy compound, for example, allyl glycidyl ether, 2-ethyl hexyl glycidyl ether, and phenyl glycidyl ether are included, and as the glycidyl amine compound, N,N,N′,N′,-tetraglycidyl-m-xylylene diamine, 1,3-bis(N,N-diglycidyl amino) cyclohexane, and the like are included.

The isocyanate compound indicates a compound having an isocyanate group in the molecule, and specifically, hexamethylene diisocyanate, trimethyl hexamethylene diisocyanate, cyclohexylene diisocyanate, xylylene diisocyanate, isophorone diisocyanate, naphthalene diisocyanate, tolylene diisocyanate, a block body or a derivative thereof, and the like are included.

Among these crosslinking agents, in particular, the epoxy compound is used in combination, and thus the strength of the easily adhesive layer increases, and an improvement in adhesiveness or wet heat resistance is able to be expected. In addition, in consideration of applying these crosslinking agents using in-line coating, it is preferable that the crosslinking agent has water solubility or water dispersibility.

In addition, in the polarizer side easily adhesive layer, particles may be contained in order to improve the blocking properties and the sliding properties of the easily adhesive layer, and as the particles, inorganic particles such as silica, alumina, and metal oxide, organic particles such as crosslinking polymer particles, and the like are included.

<<Other Additives Used in Easily Adhesive Layer>>

Further, in the polarizer side easily adhesive layer and a hard coat layer side easily adhesive layer, as necessary, an antifoaming agent, a coating property improver, a thickener, an organic lubricant, an antistatic agent, an ultraviolet absorbent, an antioxidant, a foaming agent, a dye, a pigment, and the like may be contained within a range not impairing the gist of the present invention.

In addition, in the coating composition for an easily adhesive layer used in the present invention, as necessary, a surfactant, a crosslinking agent, a dispersant, a thickener, a film forming auxiliary, an antiblocking agent, and the like may be contained.

The analysis of various components in the easily adhesive layer, for example, is able to be performed by surface analysis such as TOF-SIMS.

<<Manufacturing Method of Easily Adhesive Layer>>

When the easily adhesive layer is disposed by using the in-line coating, it is preferable that a polyester film is manufactured such that a coating liquid in which a series of compounds described above are adjusted on the basis of the concentration of solid contents of approximately 0.1 mass % to 50 mass % as an aqueous solution or a water dispersion is applied onto a polyester film. In addition, in order to improve dispersion properties with respect to water, film formability, and the like, a small amount of organic solvents may be contained in the coating liquid within a range not impairing the gist of the present invention. Only one type of the organic solvents may be used, or two or more types thereof may be suitably used.

In the present invention, the film thickness of the polarizer side easily adhesive layer of the polyester film is generally in a range of 0.002 μm to 1.0 μm, is more preferably in a range of 0.03 μm to 0.5 μm, and is even more preferably in a range of 0.04 μm to 0.2 μm. When the film thickness is less than 0.002 μm, sufficient adhesiveness may not be obtained, and when the film thickness is greater than 1.0 μm, appearance and transparency, and the blocking properties of the film may deteriorate.

In the present invention, as a method of disposing the easily adhesive layer, known coating systems of the related art such as reverse gravure coating, direct gravure coating, roll coating, die coating, bar coating, and curtain coating are able to be used. The coating system is disclosed in “Coating System” by Yuuji HARASAKI, Bookstore Maki, published in 1979.

In the present invention, drying and curing conditions at the time of forming the easily adhesive layer on the polyester film is not particularly limited, and for example, when the easily adhesive layer is disposed by using off-line coating, a generally, heat treatment may be performed on the basis of conditions of 80° C. to 200° C. and for 3 seconds to 40 seconds, or preferably, on the basis of conditions of 100° C. to 180° C. for 3 seconds to 40 seconds.

On the other hand, when the easily adhesive layer is disposed by using the in-line coating, the heat treatment may be generally performed on the basis of conditions of 70° C. to 280° C. for 3 seconds to 200 seconds.

In addition, as necessary, the heat treatment and active energy ray irradiation such as ultraviolet irradiation may be used in combination regardless of the off-line coating or the in-line coating. In the present invention, the polyester film configuring a laminated polyester film may be subjected to a surface treatment such as a corona treatment, and a plasma treatment in advance.

When the polyester film is used as the protective film of the polarizer in the polarization plate, in general, the polarizer is bonded onto the polarizer side easily adhesive layer through the adhesive agent for adhesion of the polarizer.

As the adhesive agent, known adhesive agents of the related art are able to be used, and for example, an acrylic compound such as polyvinyl alcohol, polyvinyl butyral, and polybutyl acrylate, an epoxy-based compound having a glycidyl group or an alicyclic epoxy group to be exemplified in the epoxy cyclohexane.

It is preferable that, for example, polyvinyl alcohol which is monoaxially stretched and is dyed with iodine or the like is bonded onto the prepared adhesive layer as the polarizer. The protective film, a retardation film, or the like is bonded onto the opposite side of the polarizer, and thus the polarization plate is able to be obtained.

[Manufacturing Method of Polarization Plate]

A manufacturing method of the polarization plate of the present invention includes a step of bonding the first protective film to one surface of the polarizer having polarization performance through the adhesive layer 1, and a step of bonding the second protective film to the other surface of the polarizer through the adhesive layer 2, the modulus of elasticity of the first protective film at 25° C. and relative humidity of 60% in the absorption axis direction of the polarizer is greater than or equal to 1.0 GPa and less than 4.0 GPa, the ratio of the modulus of elasticity of the first protective film at 25° C. and relative humidity of 60% in the absorption axis direction of the polarizer to the modulus of elasticity of the first protective film at 25° C. and relative humidity of 60% in the direction orthogonal to the absorption axis of the polarizer is less than or equal to 0.8, the modulus of elasticity of the second protective film at 25° C. and relative humidity of 60% in the absorption axis direction of the polarizer is greater than or equal to 2.0 GPa and less than 5.0 GPa, and the polarization plate satisfies (Expression 1) and (Expression 2) described below.

d2/d1≦0.8 (Expression 1)

d2≦40 μm (Expression 2)

(In Expression 1 and Expression 2, d1 represents a thickness of the first protective film (unit: μm), and d2 represents a thickness of the second protective film (unit: μm).)

Hereinafter, the manufacturing method of the polarization plate of the present invention will be described.

<Saponification Treatment>

The polarization plate protective film (the first protective film and the second protective film) is subjected to an alkali saponification treatment, and thus adhesiveness with respect to the material of the polarizer such as polyvinyl alcohol is applied to the polarization plate protective film, and the polarization plate protective film is able to be used as a polarization plate protective film.

As a saponification method, a method disclosed in paragraph numbers “0211” and “0212” of JP2007-86748A is able to be used.

For example, it is preferable that the alkali saponification treatment with respect to the polarization plate protective film is performed at a cycle of dipping the film surface into an alkali solution, and then of neutralizing the film surface with an acidic solution, of cleaning the film surface with water, and of drying the film surface. As the alkali solution, a potassium hydroxide solution, and a sodium hydroxide solution are included, the concentration of hydroxide ions is preferably in a range of 0.1 mol/L to 5.0 mol/L, and is more preferably in a range of 0.5 mol/L to 4.0 mol/L. The temperature of the alkali solution is preferably in a range of room temperature to 90° C., and is more preferably in a range of 40° C. to 70° C.

Instead of the alkali saponification treatment, easily adhesive processing as disclosed in JP1994-94915A (JP-H06-94915A), and JP1994-118232A (JP-H06-118232A) may be performed.

<Bonding Step of Polarizer and Protective Film>

The manufacturing method of the polarization plate of the present invention includes the step of bonding the first protective film to one surface of the polarizer having polarization performance through the adhesive layer 1, and a step of bonding the second protective film to the other surface of the polarizer through the adhesive layer 2.

The step of bonding the first protective film to one surface of the polarizer through the adhesive layer 1, and a step of bonding the second protective film to the other surface of the polarizer through the adhesive layer 2 may be simultaneously performed, or may be sequentially performed. Among them, it is preferable that the step of bonding the first protective film to one surface of the polarizer through the adhesive layer 1, and a step of bonding the second protective film to the other surface of the polarizer through the adhesive layer 2 are simultaneously performed, and it is more preferable that the step of bonding the first protective film to one surface of the polarizer through the adhesive layer 1, and a step of bonding the second protective film to the other surface of the polarizer through the adhesive layer 2 are simultaneously performed by using a roll-to-roll system.

As a method of simultaneously performing the two steps by using the roll-to-roll system, for example, a device and method disclosed in JP2012-203108A are able to be used, and the contents disclosed in JP2012-203108A are incorporated in the present invention.

A manufacturing device disclosed in JP2012-203108A is configured such that the first protective film is bonded to one surface of the polarizer and the second protective film is bonded to the other surface of the polarizer while continuously transporting a polarizer, and thus the polarization plate is manufactured and is wound around a winding roll. Typically, the protective films are respectively bonded to the both surfaces of the polarizer.

In the polarization plate of the present invention, before and after the steps of bonding the first protective film and the second protective film to the polarizer, the modulus of elasticity of the first protective film and the second protective film is rarely changed unless the first protective film and the second protective film are under an environment of high temperature and high humidity.

In the manufacturing method of the polarization plate, it is preferable that the polarization plate is prepared by using a method in which the polarization plate protective film is subjected to an alkali treatment, and is bonded to the both surfaces of the polarizer through an adhesive agent.

As the adhesive agent used for bonding a treatment surface of the polarization plate protective film to the polarizer, the adhesive agents exemplified as the main component of the adhesive layer 1 and the adhesive layer 2 are able to be used, and for example, a polyvinyl alcohol-based adhesive agent such as polyvinyl alcohol, and polyvinyl butyral, vinyl-based latex such as butyl acrylate, and the like are included.

It is preferable that the polarization plate of the present invention is laminated such that the absorption axis of the polarizer is substantially orthogonal to a direction (the TD direction) orthogonal to a film transporting direction at the time of manufacturing the polarization plate protective film (the first protective film and the second protective film) from a viewpoint of manufacturing suitability in roll-to-roll processing. Here, the expression “substantially orthogonal” indicates that an angle between the absorption axis of the polarizer and the TD direction of the polarization plate protective film is 85° to 95°, and is preferably 89° to 91°. When a shift from an orthogonal state is within 5° (preferably within 1°), the degree of polarization performance rarely decreases under a cross-nicol state of the polarization plate, and light leakage rarely occurs, and thus setting the shift from the orthogonal state to be within 5° is preferable.

In the present invention, as a method of disposing the adhesive layer 1 and the adhesive layer 2, known coating systems of the related art such as reverse gravure coating, direct gravure coating, roll coating, die coating, bar coating, and curtain coating are able to be used. The coating system is disclosed in “Coating System” by Yuuji HARASAKI, Bookstore Maki, published in 1979.

The first protective film and the second protective film may be subjected to a surface treatment such as a saponification treatment, a corona treatment, and a plasma treatment in advance.

In the manufacturing method of the polarization plate of the present invention, it is preferable that the modulus of elasticity of the second protective film at 70° C. and relative humidity of 60% in the absorption axis direction of the polarizer (also referred to as a modulus of elasticity under high temperature and high humidity) is 1.5 GPa to 3.0 GPa, and the main component of the adhesive layer 1 and the adhesive layer 2 is an aqueous adhesive agent.

Here, the respective contractile forces of the first protective film, the polarizer, and the second protective film are changed according to the temperature and humidity environment or a transporting line tension at the time of performing bonding, and thus the curling of the polarization plate occurs, but according to the configuration described above, the curling (the MD minus curling) of the polarization plate to the second protective film side in the absorption axis direction of the polarizer (the MD direction) is easily suppressed.

[Image Display Device]

An image display device of the present invention includes the polarization plate of the present invention.

As the image display device, a liquid crystal display (LCD), a plasma display (PDP), an electroluminescence display (OELD or IELD), a field emission display (FED), a touch panel, an electronic paper, and the like are able to be included. It is preferable that these image display devices include the polarization plate of the present invention on a display screen side of an image display panel.

<Bonding Method of Polarization Plate to Image Display Device>

As a method of bonding the polarization plate of the present invention to the image display device such as a liquid crystal display device, known methods are able to be used. In addition, a roll to panel manufacturing method is also able to be used, and the roll to panel manufacturing method is preferable from a viewpoint of improving productivity and yield. The roll to panel manufacturing method is disclosed in JP2011-48381A, JP2009-175653A, JP4628488B, JP4729647B, WO2012/014602A, WO2012/014571A, and the like, but is not limited thereto.

<Liquid Crystal Display Device>

It is preferable that the liquid crystal display device includes the polarization plate of the present invention, and a liquid crystal display element. Here, as the liquid crystal display element, a liquid crystal panel including a liquid crystal cell in which a liquid crystal is sealed between upper and lower substrates, and displaying an image by changing an alignment state of the liquid crystal according to voltage application is representative, and the polarization plate of the present invention is able to be applied to other various known displays such as a plasma display panel, a CRT display, and an organic EL display. Thus, when the polarization plate of the present invention including the first protective film having high retardation is applied to the liquid crystal display element, it is possible to prevent the warping of the liquid crystal display element.

Here, a rainbow-like spot is caused by the retardation of the first protective film having high retardation and the emission spectrum of the backlight light source. In the related art, as the backlight light source of the liquid crystal display device, a fluorescent tube such as a cold cathode tube or a thermal cathode tube is used. The spectral distribution of a fluorescent lamp such as a cold cathode tube or a thermal cathode tube indicates an emission spectrum having a plurality of peaks, and these incontinuous emission spectrums are combined, and thus a white light source is obtained. When light is transmitted through a film having high retardation, the spectral distribution indicates the strength of the transmitted light which is different according to a wavelength. For this reason, when the backlight light source is the incontinuous emission spectrum, only a specific wavelength is strongly transmitted, and thus the rainbow-like spot occurs.

When the image display device of the present invention is the liquid crystal display device, it is preferable that a backlight light source, and a liquid crystal cell arranged between two polarization plates are included as a configuration member. In addition, other configurations, for example, a color filter, a lens film, a diffusion sheet, an antireflection film, and the like may be suitably included.

The configuration of the backlight may be an edge light mode including an optical guide plate, a reflection plate, or the like as a configuration member, or may be a direct backlight mode, and in the present invention, it is preferable that a white light emitting diode (a white LED) is used as the backlight light source of the liquid crystal display device from a viewpoint of improving rainbow unevenness resistance. In the present invention, the white LED is a fluorescent body type LED, that is, an element emitting white light by combining a light emitting diode emitting blue light or infrared light in which a compound semiconductor is used and a fluorescent body. As the fluorescent body, an yttrium-aluminum-garnet-based yellow fluorescent body, a terbium-aluminum-garnet-based yellow fluorescent body, and the like are included. Among them, a white light emitting diode formed of a light emitting element in which the blue light emitting diode using the compound semiconductor and the yttrium-aluminum-garnet-based yellow fluorescent body are combined has a continuously wide emission spectrum and excellent light emitting efficiency, and thus is preferable as the backlight light source of the image display device of the present invention. Furthermore, here, the expression “continuous emission spectrum” indicates that there is no wavelength at which the intensity of light at least in a visible region is zero. In addition, according to the present invention, it is possible to widely use the white LED having low power consumption, and thus it is also possible to obtain an energy saving effect.

A mechanism in which the occurrence of the rainbow-like spot is suppressed according to the aspect described above is disclosed in WO2011/162198A, and the contents thereof are incorporated in the present invention.

When the image display device of the present invention is the liquid crystal display device, the arrangement of the polarization plate of the present invention is not particularly limited. It is preferable that the polarization plate of the present invention is used as a polarization plate for a visible side in the liquid crystal display device.

The arrangement of the first protective film having high retardation in the in-plane direction is not particularly limited, and in a case of a liquid crystal display device in which the polarization plate arranged on the incident light side (the light source side), the liquid crystal cell, and the polarization plate arranged on an emission light side (the visible side) are arranged, it is preferable that a polarizer protective film on the incident light side of the polarization plate arranged on the incident light side, or a polarizer protective film on the emission light side of the polarization plate arranged on the emission light side is the first protective film having high retardation in the in-plane direction. As a particularly preferable aspect, an aspect is included in which the polarizer protective film on the emission light side of the polarization plate arranged on the emission light side is the first protective film having high retardation in the in-plane direction. When the first protective film having high retardation in the in-plane direction is arranged in other positions, the polarization properties of the liquid crystal cell may be changed. It is preferable that the first protective film having high retardation in the in-plane direction is arranged in a position at which the polarization properties are not required, and thus it is preferable that the first protective film having high retardation in the in-plane direction is used as a protective film of the polarization plate in a specific position.

A schematic diagram of a preferred example of the liquid crystal display device is illustrated in FIG. 2.

A liquid crystal display device 30 illustrated in FIG. 2 includes polarization plates 20 and 21 of the present invention as the visible side polarization plate, and includes a backlight side polarization plate 23 on a liquid crystal cell 22 side. In addition, the liquid crystal display device 30 includes a backlight 26. The backlight side polarization plate 23 is not particularly limited, and as the backlight side polarization plate 23, a polarization plate which is identical to the visible side polarization plate 21 may be used, or a known polarization plate may be used.

It is preferable that the liquid crystal cell includes a liquid crystal layer, and two glass substrates disposed on both sides of the liquid crystal layer. The thickness of the glass substrate is preferably less than or equal to 0.5 mm, is more preferably less than or equal to 0.4 mm, and is particularly preferably less than or equal to 0.3 mm.

It is preferable that the liquid crystal cell of the liquid crystal display device is in an IPS mode, a VA mode, and an FFS mode.

### EXAMPLES

Hereinafter, the characteristics of the present invention will be more specifically described with reference to examples and comparative examples. Materials, used amounts, ratios, treatment contents, treatment sequences, and the like of the following examples are able to be suitably changed unless the changes cause deviation from the gist of the present invention. Therefore, the range of the present invention will not be restrictively interpreted by the following specific examples.

[Measurement Method]

<Re and Rth of First Protective Film>

Re and Rth of the first protective film used herein were measured by the following method.

An alignment axis direction of an obtained PET film which was used as the first protective film was obtained by using two polarization plates, and a rectangle of 4 cm×2 cm was cut out such that the alignment axis direction was orthogonal, and thus a sample for measurement was obtained. In the sample, orthogonal biaxial refractive indexes (Nx and Ny), and a refractive index (Nz) in the thickness direction were obtained by using an Abbe's refractometer (NAR-4T, manufactured by Atago Co., Ltd., and a measurement wavelength of 589 nm). Further, a thickness d1 (nm) of the first protective film was measured by using an electric micrometer (Miritoron 1245D, manufactured by Fine Liu full Ltd.), and the unit was converted into nm Re and Rth were respectively calculated from the measured values of Nx, Ny, Nz, and d1.

<Re and Rth of Second Protective Film>

Re and Rth of the second protective film used herein were measured by the following method.

A sample film was subjected to humidity conditioning at 25° C. and relative humidity of 60% for 24 hours, a phase difference at a wavelength of 590 nm was measured at 25° C. and relative humidity of 60% by using an automatic birefringence meter (KOBRA-21ADH: manufactured by Oji Scientific Instruments) from a direction perpendicular to the film surface and a direction inclined from a normal line of the film surface at every 10° from +50° to −50° by using a slow axis as a rotational axis, and thus an in-plane retardation value (Re) and a retardation value (Rth) in a film thickness direction were calculated.

<Film Thickness of Protective Film>

The sectional surface of the manufactured polarization plate was observed by using a scanning type microscope (SEM), and thus the film thickness of the first protective film and the second protective film was measured.

<Modulus of Elasticity of Protective Film>

The modulus of elasticity of the first protective film and the second protective film in the MD direction and the TD direction was measured by preparing a sample having a length in the measurement direction of 200 mm and a width of 10 mm, and by setting the shape of the sample to have a width of 10 mm and a length between chucks of 100 mm using Strograph V10-C manufactured by Toyo Seiki Kogyo Co., Ltd. Furthermore, the measurement of the modulus of elasticity in an atmosphere of 25° C. and relative humidity of 60% and the measurement of the modulus of elasticity in an atmosphere of 70° C. and relative humidity of 60% were performed by using the first protective film and the second protective film as a material before preparing the polarization plate as a sample.

In the maximum direction of the in-plane modulus of elasticity of the first protective film, the sound velocity of a film of which the humidity was conditioned in an atmosphere of 25° C. and relative humidity of 60% for 2 hours or more was measured in an atmosphere of 25° C. and relative humidity of 60% by dividing a 360-degree area into 32 sections using a sound velocity measurement device “SST-2501, manufactured by Nomura Shoji Co., Ltd.”, and thus the maximum speed direction was obtained as the maximum direction of the in-plane modulus of elasticity. Furthermore, in any example described below, it was known that the maximum direction of the in-plane modulus of elasticity of the first protective film was the TD direction, and was perpendicular to the absorption axis of the polarizer.

### Manufacturing Example 1

### Preparation of First Protective Film

<Stretched PET 100 μM>

(Raw Material Polyester 1)

As described below, a raw material polyester 1 (Sb catalyst-based PET) was obtained by a continuous polymerization device using a direct esterification method in which a terephthalic acid directly reacted with ethylene glycol, water was removed from the reactant, and the reactant was esterified, and then was subjected to polycondensation under reduced pressure.

(1) Esterification Reaction

4.7 tons of a high purity terephthalic acid and 1.8 tons of ethylene glycol were mixed for 90 minutes in order to form slurry, and were continuously supplied to a first esterification reactor at a flow rate of 3800 kg/h. Further, an ethylene glycol solution of antimony trioxide was continuously supplied to the reactor, and a reaction was performed under stirring at a temperature of 250° C. in the reactor for an average retention time of approximately 4.3 hours. At this time, the antimony trioxide was continuously added such that the added amount of Sb was 150 ppm in an element conversion value.

This reactant was transported to a second esterification reactor, and a reaction was performed under stirring at a temperature of 250° C. in the reactor for an average retention time of approximately 1.2 hours. An ethylene glycol solution of magnesium acetate and an ethylene glycol solution of trimethyl phosphite were continuously supplied to the second esterification reactor such that the added amount of Mg and the added amount of P were respectively 65 ppm and 35 ppm in the element conversion value.

(2) Polycondensation Reaction

An esterification reaction product obtained as described above was continuously supplied to the first polycondensation reactor, polycondensation was performed under stirring at a reaction temperature of 270° C. and a pressure of 20 torr (2.67×10⁻³ MPa) in the reactor for an average retention time of approximately 1.8 hours.

Further, the product was transported to the second polycondensation reactor, and in this reactor, a reaction (polycondensation) was performed under stirring in conditions of a temperature of 276° C. in the reactor and a pressure of 5 torr (6.67×10⁻⁴ MPa) in the reactor for a retention time of approximately 1.2 hours.

Subsequently, the product was further transported to a third polycondensation reactor, and in this reactor, a reaction (polycondensation) was performed in conditions of a temperature of 278° C. in the reactor and a pressure of 1.5 torr (2.0×10⁻⁴ MPa) in the reactor for a retention time of 1.5 hours, and thus a reactant (polyethylene terephthalate (PET)) was obtained.

Next, the obtained reactant was ejected into cool water in the shape of a strand, and immediately after that, the reactant was cut, and thus a polyester pellet<a sectional surface: a long diameter of approximately 4 mm, a short diameter of approximately 2 mm, and a length of approximately 3 mm>was prepared.

In the obtained polymer, intrinsic viscosity IV was 0.63. This polymer was set to a raw material polyester 1.

A raw material polyester 1 was dissolved in a mixed solvent of 1,1,2,2-tetrachloroethane/phenol (=2/3 [mass ratio]), and IV was obtained from the solution viscosity of the mixed solvent at 25° C.

(Raw Material Polyester 2)

10 parts by mass of a dried ultraviolet absorbent (2,2′-(1,4-phenylene)bis(4H-3,1-benzoxazinone-4-one) and 90 parts by mass of the raw material polyester 1 (IV=0.63) were mixed, and a raw material polyester 2 containing an ultraviolet absorbent was obtained by using a kneading extruder.

(Film Molding Step)

The raw material polyester 1 (90 parts by mass) and the raw material polyester 2 containing the ultraviolet absorbent (10 parts by mass) were dried such that the moisture content was less than or equal to 20 ppm, and then were put into a hopper 1 of a monoaxial kneading extruder 1 having a diameter of 50 mm, and were melted at 300° C. in the extruder 1. According to the following extrusion conditions, the melted resin was extruded from a die through a gear pump and a filter (a hole diameter of 20 μm).

As the extrusion conditions of the melted resin, a pressure variation was set to 1%, and the temperature distribution of the melted resin was set to 2%, and thus the melted resin was extruded from the die. Specifically, a back pressure was increased by 1% with respect to the average pressure in a barrel of the extruder, and the pipe temperature of the extruder was heated at a temperature which was 2% higher than the average temperature in the barrel of the extruder.

The melted resin extruded from the die was extruded onto a cooling cast drum of which the temperature was set to 25° C., and adhered to the cooling cast drum by using a static electricity application method. Peeling was performed by using a stripping roll which was arranged to face the cooling cast drum, and thus an unstretched polyester film 1 was obtained.

The obtained unstretched polyester film 1 was introduced to a tenter (a horizontal stretching machine), and was horizontally stretched in the TD direction (a film width direction, and a horizontal direction) in the following conditions by using the following method and conditions while gripping an end portion of the film with a clip, and thus a PET film (hereinafter, referred to as stretched PET 100 μm) having a thickness of 100 μm, retardation Re in the in-plane direction of 10000 nm, and retardation Rth in the film thickness direction of 11000 nm was manufactured.

<<Conditions>>
Horizontally Stretched Temperature: 90° C.
Horizontally Stretching Ratio: 4.3 times

(Thermal Fixation Portion)

Subsequently, a thermal fixation treatment was performed while controlling the film surface temperature of the polyester film to be in the following range.

<Conditions>
Thermal Fixation Temperature: 180° C.
Thermal Fixation Time: 15 seconds

(Heat Relaxing Portion)

The polyester film after the thermal fixation was heated at the following temperature, and thus the film was relaxed.
Heat Relaxing Temperature: 170° C.
Heat Relaxing Rate: TD direction (film width direction, and horizontal direction) 2%

(Cooling Portion)

Next, the polyester film after the heat relaxation was cooled to a cooling temperature of 50° C.

### Manufacturing Example 2

### Stretched PET 80 μm

A PET film (hereinafter, referred to as stretched PET 80 μm) having retardation Re in the in-plane direction of 8100 nm, and retardation Rth in the film thickness direction of 9300 nm was manufactured by the same method as that in Manufacturing Example 1 except that the thickness of the completed film was 80 μm.

### Manufacturing Example 3

### Stretched PET 60 μm

A PET film (hereinafter, referred to as stretched PET 60 μm) having retardation Re in the in-plane direction of 6100 nm, and retardation Rth in the film thickness direction of 6900 nm was manufactured by the same method as that in Manufacturing Example 1 except that the thickness of the completed film was 60 μm.

### Manufacturing Example 4

### Three-Layer Co-Extrusion PET 80 μm

—Film Molding Step—

The raw material polyester 1 (90 parts by mass) and the raw material polyester 2 containing the ultraviolet absorbent (10 parts by mass) were dried such that the moisture content was less than or equal to 20 ppm, and then were put into the hopper 1 of the monoaxial kneading extruder 1 having a diameter of 50 mm, and were melted at 300° C. in the extruder 1 (an intermediate layer: a layer II).

In addition, the raw material polyester 1 was dried such that the moisture content was less than or equal to 20 ppm, and then was put into a hopper 2 of a monoaxial kneading extruder 2 having a diameter of 30 mm, and was melted at 300° C. in the extruder 2 (an outer layer: a layer I, and an outer layer: a layer III).

These two types of polymer melted products respectively passed through a gear pump and a filter (a hole diameter of 20 μm), and then were laminated such that a polymer extruded from the extruder 1 became the intermediate layer (the layer II) and a polymer extruded from the extruder 2 became the outer layer (the layer I and the layer III) at two types of three-layer merging blocks, and were extruded from the die in the shape of a sheet.

As the extrusion conditions of the melted resin, a pressure variation was set to 1%, and the temperature distribution of the melted resin was set to 2%, and thus the melted resin was extruded from the die. Specifically, a back pressure was increased by 1% with respect to the average pressure in the barrel of the extruder, and the pipe temperature of the extruder was heated at a temperature which was 2% higher than the average temperature in the barrel of the extruder.

The melted resin extruded from the die was extruded onto the cooling cast drum of which the temperature was set to 25° C., and adhered to the cooling cast drum by using a static electricity application method. Peeling was performed by using a stripping roll which was arranged to face the cooling cast drum, and thus an unstretched polyester film 2 was obtained. At this time, the ejected amount of each of the extruders was adjusted such that a ratio of the thicknesses of the layer I, the layer II, and the layer III was 10:80:10.

The obtained unstretched polyester film 2 was horizontally stretched in the same conditions as those in Manufacturing Example 1, and thus a PET film (hereinafter, referred to as Three-Layer Co-Extrusion PET 80 μm) having a thickness of 80 μm, retardation Re in the in-plane direction of 8200 μm, and retardation Rth in the film thickness direction of 9400 nm was manufactured.

### Manufacturing Example 5

### 80 μm PET-A

A PET film (referred to as 80 μm PET-A) having retardation Re in the in-plane direction of 1200 nm and retardation Rth in the film thickness direction of 4700 nm was manufactured by the same method as that in Manufacturing Example 1 except that the obtained unstretched polyester film 1 was further stretched at a stretching ratio of 3 times in a vertical direction, and the thickness of the completed film was 80 μm.

### Manufacturing Example 6

### HC Layer-Attached Stretched PET 80 μm

—Formation of Easily Adhesive Layer—

(1) Formation of Hard Coat Layer Side Easily Adhesive Layer

The following compounds were mixed at the following ratio, and thus a coating liquid H1 for a hard coat layer side easily adhesive layer was prepared. The coating liquid H1 for a hard coat layer side easily adhesive layer was applied onto the stretched PET 80 μm obtained in Manufacturing Example 2 such that the film thickness was 0.09 μm.

Coating Liquid H1 for Hard Coat Layer Side Easily Adhesive Layer

Polyester Resin: (IC) 60 parts by mass

Acrylic Resin: (II) 25 parts by mass

Melamine Compound: (VIB) 10 parts by mass

Particles: (VII) 5 parts by mass

Hereinafter, the detail of the used compounds will be described.

Polyester Resin: (IC)

Sulfonic Acid-Based Water Dispersion of Polyester Resin Copolymerized in Monomer Having Following Composition

Monomer Composition: (an acid component) terephthalic acid/isophthalic acid/5-sodium sulfoisophthalic acid//(a diol component) ethylene glycol/1,4-butane diol/diethylene glycol=56/40/4//70/20/10 (mol %)

Acrylic Resin: (II)

Water Dispersion of Acrylic Resin Polymerized in Monomer Having Following Composition

Emulsion Polymer of Ethyl Acrylate/n-Butyl Acrylate/Methyl Methacrylate/n-Methylol Acrylamide/Acrylic Acid=65/21/10/2/2 (mass %) (an emulsifier: an anionic surfactant)

Urethane Resin: (IIIB)

A water dispersion of a urethane resin obtained by neutralizing a prepolymer formed of 400 parts by mass of polycarbonate polyol which was formed of 1,6-hexane diol and diethyl carbonate and had a number average molecular weight of 2000, 10.4 parts by mass of neopentyl glycol, 58.4 parts by mass of isophorone diisocyanate, and 74.3 parts by mass of a dimethylol butanoic acid with triethyl amine, and by performing chain extension with respect to the prepolymer with isophorone diamine.

Melamine Compound: (VIB) hexamethoxy methyl melamine

Particles: (VII) silica sol having an average particle diameter of 65 nm

<Formation of Hard Coat Layer by Using Coating>

After that, a mixed coating liquid (acryl-1) having the following composition was applied onto the surface of the stretched PET 80 μm obtained in Manufacturing Example 2 onto which the coating liquid H1 for a hard coat layer side easily adhesive layer was applied and was dried such that the dried film thickness was 5 μm, and was cured with ultraviolet irradiation, and thus a hard coat layer was formed.

Dipentaerythritol Hexaacrylate 85 parts by mass

2-Hydroxy-3-Phenoxy Propyl Acrylate 15 parts by mass

Photopolymerization Initiator (a trade name: Irgacure 184, manufactured by Ciba Specialty Chemicals) 5 parts by mass

Methyl Ethyl Ketone 200 parts by mass

A PET film attached with the hard coat layer obtained in this way in which retardation Re in the in-plane direction was 8100 nm and retardation Rth in the film thickness direction was 9300 nm was set to HC layer-attached stretched PET 80 μm.

### Manufacturing Example 11

### Preparation of Second Protective Film

<Stretched DAC 35 μm>

(Preparation of Cellulose Acylate)

Cellulose acylate was synthesized by using a method disclosed in JP1998-45804A (JP-H10-45804A) and JP1996-231761A (JP-H08-231761A), and the degree of substitution was measured. Specifically, a sulfuric acid (7.8 parts by mass with respect to 100 parts by mass of cellulose) was added as a catalyst, and a carboxylic acid which was a raw material of an acyl substituent group was added, and an acylation reaction was performed at 40° C. At this time, the amount of the carboxylic acid was adjusted, and thus the degree of substitution was adjusted. In addition, maturing was performed at 40° C. after the acylation. Further, a low molecular weight component of the cellulose acylate was cleaned with acetone and was removed.

(Preparation of Cellulose Acylate Solution C01 for Core Layer)

The compositions were put into a mixing tank and were stirred, and each of the components was dissolved, and thus a cellulose acylate solution was prepared. The amount of solvent (methylene chloride and methanol) was suitably adjusted such that concentration of solid contents of each of the cellulose acylate solutions was 22 (mass %).
Cellulose Acetate (a degree of substitution of 2.43) 100.0 parts by mass
Compound A 19.0 parts by mass
Compound B 5.0 parts by mass
Methylene Chloride 365.5 parts by mass
Methanol 54.6 parts by mass

The compound A described above was denoted by terephthalic acid/succinic acid/propylene glycol/ethylene glycol copolymer (Copolymerization Ratio [mol %]=27.5/22.5/25/25).

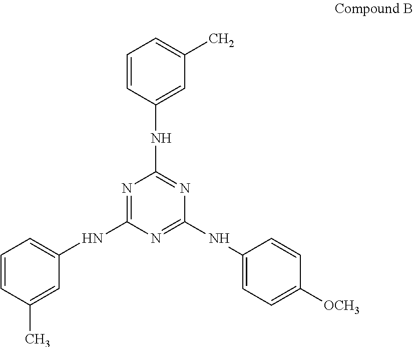 [SMILES: COc1ccc(Nc2nc(Nc3cccc(C)c3)nc(Nc3cccc(C)c3)n2)cc1]

(Preparation of Cellulose Acylate Solution S01 for Skin Layer)

The following compositions were put into the mixing tank and were stirred, and each of the components was dissolved, and thus a cellulose acylate solution was prepared. The amount of solvent (methylene chloride and methanol) was suitably adjusted such that the concentration of solid contents of each of the cellulose acylate solutions was 19.7 (mass %).
Cellulose Acetate (a degree of substitution of 2.79) 100.0 parts by mass
Compound A 11.0 parts by mass
Silica Fine Particles R972 (manufactured by Nippon Aerosil Co., Ltd.) 0.15 parts by mass
Methylene Chloride 395.0 parts by mass
Methanol 59.0 parts by mass

(Preparation of Cellulose Acylate Film)

The cellulose acylate solution C01 was casted such that the film thickness of the core layer after being dried was 42 μm, and the cellulose acylate solution S01 was casted such that the film thickness of a skin layer A and skin layer B after being dried was 3 μm. The obtained web (film) was peeled off from a band, was interposed between the clip, and was horizontally stretched at a stretching temperature of 140° C. and a stretching ratio of 1.08 times by using a tenter when the residual amount of the solvent with respect to the total mass of the film was 70% to 5%.

After that, the film was detached from the clip and was dried at 130° C. for 20 minutes, and then was horizontally stretched again at a stretching temperature of 180° C. and a stretching ratio of 1.25 times by using the tenter.

Furthermore, the residual amount of the solvent was obtained by the following expression.

Residual Amount of Solvent (mass %)={(M−N)/N}×100

Here, M represents the mass of the web at an arbitrary time point, and N represents the mass of the web when the web in which M has been measured was dried at 120° C. for 2 hours. Thus, a cellulose acylate film (hereinafter, referred to as stretched DAC 35 μm) was obtained. The film thickness was 35 μm. Furthermore, Re(550) was 55 nm, and Rth(550) was 110 nm.

### Manufacturing Example 12

### Stretched DAC 40 μm

A cellulose acylate film (hereinafter, referred to as stretched DAC 40 was manufactured by the same method as that in the formation of the stretched DAC 35 μm except that the thickness of the completed film was 40 μm (a film thickness of 40 μm, and Re=60 nm and 125 nm).

### Manufacturing Example 14

### Stretched DAC 65 μm

A cellulose acylate film (hereinafter, referred to as stretched DAC 65 μm) was manufactured by the same method as that in the formation of the stretched DAC 35 μm except that the thickness of the completed film was 65 μm without using the compound B (a film thickness of 65 μm, Re=54 nm, and Rth=130 nm).

### Manufacturing Example 21

### Stretched CAP 35 μm

(Preparation of Cellulose Acylate Solution)

Cellulose acylate and the following compositions were put into a mixing tank and were stirred, and each of the components was dissolved, and thus a cellulose acylate solution 21 was prepared.

Composition of Cellulose Acylate Solution 21

| | |
|---|---|
| Cellulose Acylate Having Degree of | 100.0 parts by mass |
| Acetyl Substitution of 1.6 and | |
| Degree of Propionyl Substitution of 0.9 | |
| Scurose Benzoate Having Degree of | 8.0 parts by mass |
| Benzoate Substitution of 6.0 | |
| Compound B | 3.0 parts by mass |
| Following Additives (polycondensed Ester | 2.0 parts by mass |
| of a carboxylic acid and diol) | |
| Methylene Chloride (a first solvent) | 400.0 parts by mass |
| Ethanol (a second solvent) | 40.0 parts by mass |

Polycondensed ester: polycondensed ester of a terephthalic acid and an adipic acid as a dicarboxylic acid, and ethylene glycol and 1,2-propylene glycol as diol (terephthalic acid:adipic acid:ethylene glycol:1,2-propylene glycol=55:45:50:50 (molar ratio)) (a terminal: an acetyl group, and a molecular weight of 1200)

<Preparation of Matting Agent Solution>

The following compositions were put into a dispersing machine and were stirred, and each of the components was dissolved, and thus a matting agent solution was prepared.

Composition of Matting Agent Solution

| | |
|---|---|
| Silica Particles Having Average | 1.6 parts by mass |
| Particle Size of 16 nm (AEROSIL R972, | |
| manufactured by Nippon Aerosil Co., Ltd.) | |
| Methylene Chloride (the first solvent) | 78.9 parts by mass |
| Ethanol (the second solvent) | 8.8 parts by mass |
| Cellulose Acylate Solution 21 | 0.3 parts by mass |

1.0 part by mass of the matting agent solution described above was filtered, and then 92.7 parts by mass of the cellulose acylate solution 21 was added thereto, was mixed in by using a inline mixer, was casted by using a band casting machine, was dried at a dry air temperature of 30° C., and thus the film was stripped. A film having a residual content of the solvent of 15% was horizontally stretched at an atmospheric temperature of 130° C. and a stretching ratio of 1.30 times by using a tenter. After that, the film was detached from the clip, and was dried at 120° C. for 40 minutes, and a cellulose acylate film having a width of 2000 mm (hereinafter, referred to as stretched CAP 35 μm) was obtained (a film thickness of 35 μm, Re=44 nm, and Rth=105 nm).

### Manufacturing Example 22

### Stretched CAP 40 μm

A cellulose acylate film (hereinafter, referred to as stretched CAP 40 μm) was manufactured by the same method as that in the formation of stretched CAP 35 μm except that the thickness of the completed film was 40 μm (a film thickness of 40 μm, Re=51 nm, and Rth=117 nm).

### Manufacturing Example 24

### Stretched CAP 65 μm

A cellulose acylate film (hereinafter, referred to as stretched CAP 65 μm) was manufactured by the same method as that in the formation of the stretched CAP 35 μm except that the thickness of the completed film was 65 μm without using the compound B (a film thickness of 65 μm, Re=63 nm, and Rth=150 nm).

### Manufacturing Example 31

### Stretched TAC 35 μm

[Dope Preparation]

(Cellulose Acylate Solution 31)

The following compositions were put into a mixing tank, and each of the components was dissolved by being stirred while being heated, and thus each of the components was sufficiently dissolved.

Composition of Cellulose Acylate Solution 31

| | |
|---|---|
| Cellulose Acylate having Degree of | 100.0 parts by mass |
| Acetyl Substitution of 2.81 | |
| Following Additives (polycondensed | 9.0 parts by mass |
| ester of a carboxylic acid and diol) | |
| Optical Increasing Agent A | 7.0 parts by mass |
| Dichloromethane | 404.3 parts by mass |
| Methanol | 60.4 parts by mass |

Polycondensed Ester: polycondensed ester of a terephthalic acid, a phthalic acid, a succinic acid, and an adipic acid as a dicarboxylic acid, and ethylene glycol as diol (terephthalic acid:phthalic acid:succinic acid:adipic acid:ethylene glycol=45:5:30:20:100 (molar ratio)) (a terminal: an acetyl group, and a molecular weight of 900)

Optical Increasing Agent A

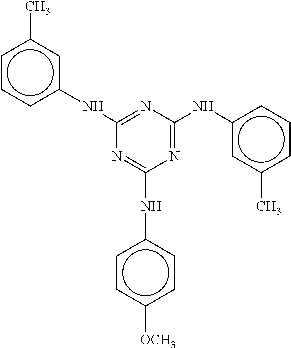

(Matting Agent Dispersion Liquid)

The following composition containing a cellulose acylate solution 31 prepared by the method described above was put into a dispersing machine, and thus a matting agent dispersion liquid was prepared.

Composition of Matting Agent Dispersion Liquid

| | |
|---|---|
| Silica Particles Having Average | 2.0 parts by mass |
| Particle Diameter of 16 nm (aerosil R972, | |
| manufactured by Nippon Aerosil Co., Ltd.) | |
| Dichloromethane | 72.2 parts by mass |
| Methanol | 10.8 parts by mass |
| Cellulose Acylate Solution 31 | 10.5 parts by mass |

(Solution of Optical Increasing Agent A)

The following composition containing the cellulose acylate solution 31 prepared by the method described above was put into a mixing tank, and was stirred while being heated, and thus a solution of an optical increasing agent A was prepared.

Composition of Solution of Optical Increasing Agent A

| | |
|---|---|
| Optical Increasing Agent A described above | 20.0 parts by mass |
| Dichloromethane | 58.2 parts by mass |
| Methanol | 8.7 parts by mass |
| Cellulose Acylate Solution 31 | 13.2 parts by mass |

(Dope for Outer Layer)

The cellulose acylate solution 31, the matting agent dispersion liquid, and the solution of the optical increasing agent A were mixed such that the content of a plasticizer was 9.0 parts by mass, the content of the optical increasing agent A was 7.0 parts by mass, and the content of the silica particles having an average particle diameter of 16 nm (aerosil R972, manufactured by Nippon Aerosil Co., Ltd.) was 0.14 parts by mass with respect to 100 parts by mass of cellulose acylate, and thus a doping solution for an outer layer was prepared using cocasting.

(Dope for Inner Layer)

The cellulose acylate solution 31, and the solution of the optical increasing agent A were mixed such that the content of a plasticizer was 9.0 parts by mass, and the content of the optical increasing agent A was 7.0 parts by mass with respect to 100 parts by mass of cellulose acylate, and thus a doping solution for an inner layer was prepared by using cocasting.

A doping solution for an outer layer and a doping solution for an inner layer were homogeneously and simultaneously laminated and cocasted on a stainless steel band support to have a three-layer structure of a support surface side outer layer, an inner layer, and an air interface side outer layer by using a band casting device. The three-layer film was peeled off from the stainless steel band support by evaporating the solvent from the stainless steel band support. The film was stretched such that a vertically (MD) stretching ratio was 1.02 times by applying tension at the time of the peeling-off, both end portions of the film were gripped by a tenter, and the film was stretched in the width direction (horizontally stretched) such that a stretching ratio in the width (TD) direction was 1.30 times. The film was dried in a drying zone of 130° C. for 20 minutes while being transported after the stretching. The film was slit to have a width of 2000 mm after the drying, and thus a cellulose acylate film (hereinafter, referred to as stretched TAC 35 μm) was obtained in which a film thickness ratio of each of the layers was support surface side outer layer:inner layer:air interface side outer layer=3:94:3 (a film thickness of 35 μm, Re=40 nm, Rth=103 nm).

### Manufacturing Example 32

### Stretched TAC 40 μm

A cellulose acylate film (hereinafter, referred to as stretched TAC 40 μm) was manufactured by the same method as that in the formation of the stretched TAC 35 μm except that the thickness of the completed film was 40 μm (40 μm, Re=46 nm, and Rth=118 nm).

### Manufacturing Example 33

### Stretched TAC 65 μm

A cellulose acylate film (hereinafter, referred to as stretched TAC 65 μm) was manufactured by the same method as that in the formation of the stretched TAC 35 μm except that the added amount of the compound B was 3.5 parts by mass, and the thickness of the completed film was 65 μm (a film thickness of 65 μm, Re=47 nm, and Rth=120 nm).

[Examples 101 to 106, 108, 109, 201 to 206, and 301 to 306, and Comparative Examples 101, 102, 201, 202, 301, and 302]

<Adhesion of Polarizer and Protective Film>

The first protective film and the second protective film manufactured in Manufacturing Examples described above were used, and the first protective film and the second protective film were bonded to the polarizer through the adhesive layer according to the following method.

(Formation of Polarizer Side Easily Adhesive Layer)

The following compounds were mixed as the following ratio, and thus a coating liquid P1 for a polarizer side easily adhesive layer was prepared.

(1) Synthesis of Copolymerization Polyester Resin (A-1)

Dimethyl Terephthalate 194.2 parts by mass

Dimethyl Isophthalate 184.5 parts by mass

Dimethyl-5-Sodium Sulfoisophthalate 14.8 parts by mass

Diethylene Glycol 233.5 parts by mass

Ethylene Glycol 136.6 parts by mass

Tetra-n-Butyl Titanate 0.2 parts by mass

The compounds described above were prepared, and were subjected to transesterification at a temperature of 160° C. to 220° C. for 4 hours. Subsequently, the temperature was increased to 255° C., and the pressure of a reaction system was gradually reduced, and then the compounds reacted with each other under a reduced pressure of 30 Pa for 1 hour and 30 minutes, and thus a copolymerization polyester resin (A-1) was obtained.

(2) Preparation of Polyester Water Dispersion (Aw-1)

Copolymerization Polyester Resin (A-1) 30 parts by mass

Ethylene Glycol N-Butyl Ether 15 parts by mass

The compounds described above were prepared, were heated at 110° C., and were stirred, and thus the resin was dissolved. The resin was completely dissolved, and then 55 parts by mass of water was gradually added to a polyester solution while being stirred. The solution was cooled to room temperature while being stirred after the addition, and thus a milky white polyester water dispersion (Aw-1) having a solid content of 30 mass % was prepared.

(3) Preparation of Aqueous Solution of Polyvinyl Alcohol (Bw-1)

90 parts by mass of water was prepared, and 10 parts by mass of a polyvinyl alcohol resin (manufactured by Kuraray Co., Ltd.) (B-1) having a degree of saponification of 88% and a degree of polymerization of 500 was gradually added thereto while being stirred. The solution was heated up to 95° C. while being stirred after the addition, and thus the resin was dissolved. The solution was cooled to room temperature while being stirred after the dissolution, an aqueous solution of polyvinyl alcohol (Bw-1) having a solid content of 10 mass % was prepared.

Polyisocyanate Compound Having Isocyanurate Structure Using Hexamethylene Diisocyanate as Raw Material (Duranate TPA, manufactured by Asahi Kasei Chemicals Corporation) 100 parts by mass

Propylene Glycol Monomethyl Ether Acetate 55 parts by mass

Polyethylene Glycol Monomethyl Ether (an average molecular weight of 750) 30 parts by mass

The compounds described above were prepared and were held at 70° C. for 4 hours in a nitrogen atmosphere. After that, the temperature of a reaction liquid was decreased to 50° C., and 47 parts by mass of methyl ethyl ketoxime was dropped. The infrared spectrum of the reaction liquid was measured, and disappearance of the absorption of an isocyanate group was confirmed, and thus a block polyisocyanate water dispersion liquid (C-1) having a solid content of 75 mass % was obtained to use as Block Isocyanate-Based Crosslinking Agent (C-1) below.

The following coating agents were mixed, and thus the coating liquid P1 for a polarizer side easily adhesive layer was prepared in which the mass ratio of polyester-based resin (A)/polyvinyl alcohol-based resin (B) was 70/30.

Water 40.61 mass %

Isopropanol 30.00 mass %

Polyester Water Dispersion (Aw-1) 11.67 mass %

Aqueous Solution of Polyvinyl Alcohol (Bw-1) 15.00 mass %

Block Isocyanate-Based Crosslinking Agent (C-1) 0.67 mass %

Particles (silica sol having an average particle diameter of 100 nm, and a concentration of solid contents of 40 mass %) 1.25 mass %

Catalyst (an organic tin-based compound, and a concentration of solid contents of 14 mass %) 0.3 mass %

Surfactant (a silicon-based surfactant, and a concentration of solid contents of 10 mass %) 0.5 mass %

(Coating of Easily Adhesive Layer to Polyester Film)

The coating liquid P1 for a polarizer side easily adhesive layer was applied onto one side of the unstretched polyester film 1 by using a reverse roll method while adjusting the coated amount after drying to be 0.12 g/m².

A cellulose acylate film used as the second protective film shown in the following table continuously passed through an aqueous solution of hydroxide sodium set to 1.5, and was dipped at 55° C. for 2 minutes. The film was cleaned in a water cleaning bath at room temperature, and was neutralized at 30° C. by using a sulfuric acid set to 0.1. The film was cleaned again in the water cleaning bath at room temperature, and was dried by hot air at 100° C. Thus, the surface of the cellulose acylate film was saponified.

Subsequently, a roll-like polyvinyl alcohol film having a thickness of 80 μm was continuously stretched at a stretching ratio of 5 times in the transporting direction in an aqueous solution of iodine, and then was dried, and thus a polarizer having a thickness of 20 μm was obtained.

The surfaces of a cellulose acylate film sample used as the saponified second protective film and a polyester film sample used as the strip-like (elongated) first protective film on which the coating liquid P1 for a polarizer side easily adhesive layer was applied were set on the polarizer side by using an aqueous solution of polyvinyl alcohol of 3% (Polarizer-117H, manufactured by Kuraray Co., Ltd.) used as the adhesive agent, and were laminated in roll-to-roll processing through the adhesive agent such that the polarizer was interposed therebetween, the obtained laminate was heated at 70° C. and relative humidity of 60% while being transported on a roll in order to cure the adhesive agent, and thus the first protective film and the second protective film were bonded to the polarizer. Thus, a polarization plate of each of Examples and Comparative Examples was obtained in which both surfaces of the polarizer were protected by the first protective film and the second protective film.

<Preparation of Image Display Device 1>

Two polarization plates of a commercially available VA type liquid crystal television (39E61HR, manufactured by Skyworth Group Co., Ltd.) were peeled off, and the polarization plates of each of Examples and Comparative Examples were respectively bonded onto a front side (a visible side) and a rear side (an invisible side) through the adhesive agent such that the second protective films are respectively on a liquid crystal cell side. The polarization plates were cross-nicol arranged such that the absorption axis of the polarization plate on the front side is the longitudinal direction (a right and left direction) and the transmission axis of the polarization plate on the rear side is the longitudinal direction (the right and left direction). The thickness of the glass used in the liquid crystal cell was 0.5 mm 39E61HR manufactured by Skyworth Group Co., Ltd. includes an LED backlight, and the LED backlight corresponds to a white light source having a continuous emission spectrum.

The display properties thereof were excellent.

A liquid crystal display device obtained in this way was an image display device 1 of each of Examples and Comparative Examples.

[Evaluation]

<<Evaluation of Polarization Plate>>

<Evaluation of MD Curling>

A test piece having a size of (TD) 1.5 cm×(MD) 15 cm was cut out from the polarization plate prepared in this way, was placed in a temperature and humidity environment of 25° C. and relative humidity of 60% for 4 hours or more, and then the floating amount of four corners (the curling amount in the MD direction) was measured. The results are shown in Tables 1 to 3. At this time, the floating amount at the time of placing the outer side upwardly was set to a plus direction. When the prepared sample warped to the inner side, the floating amount was not able to be measured even when the outer side was placed upwardly, and thus the film was vertically turned over in order to place the inner side upwardly, the floating amount was measured, and a minus reference numeral was applied thereto. Furthermore, when the test piece was cut out, the test piece was cut out from the center portion of the polarization plate.

It was most preferable that the average floating amount of the four corners of the polarization plate (the curling amount in the MD direction) was greater than or equal to −1 mm, and this most preferred average floating amount was set to A.

It was second most preferable that the average floating amount was greater than or equal to −5 mm and less than −1 mm, and this second most preferred average floating amount was set to B.

It was third most preferable that the average floating amount was greater than or equal to −10 mm and less than −5 mm, and this third most preferred average floating amount was set to C.

It was not preferable that the average floating amount was less than −10 mm, and this unpreferred average floating amount was set to D. This is because when the polarization plate was strongly curled in the minus direction, bubbles could easily enter at the time of bonding the polarization plate to the liquid crystal cell.

In practice, it is necessary that the evaluation is A, B or C, it is preferable that the evaluation is A or B, and it is more preferable that the evaluation is A.

<<Evaluation of Liquid Crystal Display Device Panel>>

<Evaluation of Rainbow-Like Unevenness>

The rainbow-like unevenness of the prepared image display device 1 of each of Examples and Comparative Examples at the time of white display was visually evaluated by a plurality of observers.

˜Evaluation Index˜

A: The rainbow-like unevenness was rarely observed.

B: Slight rainbow-like unevenness was observed to the extent of being visible.

C: The rainbow-like unevenness was clearly observed.

It is preferable that the evaluation is A or B, and it is more preferable that the evaluation is A.

<Evaluation of Unevenness of Front Surface>

The image display device 1 of each of Examples and Comparative Examples prepared in this way was heated at 40° C. and relative humidity of 95% for 24 hours, and then a backlight of the liquid crystal display device was lit at 25° C. and relative humidity of 60%, and the light leakage on the four corners of a panel was evaluated after 5 hours to 10 hours from the lighting on the basis of a difference between the average brightness of the entire screen and the brightness of a portion in which the light leakage on the four corners was considerable by imaging black display screen from a screen front surface using a camera for brightness measurement “ProMetric” (manufactured by Radiant Imaging).

˜Evaluation Index˜

A: The light leakage on the four corners of the panel is not visible. (The degree of the light leakage of the panel is same as that before being heated.)

B: Slight light leakage is visible in one to two corners among the four corners of the panel, but the light leakage is allowable.

C: Slight light leakage is visible in three to four corners among the four corners of the panel, but the light leakage is allowable.

D: The light leakage on the four corners of the panel is significant.

In addition, the backlight of the liquid crystal display device was heated in a DRY environment of 40° C. for 2 hours, and then was lit at 25° C. and relative humidity of 60% for 24 hours, and the same evaluation was performed instead of lighting the backlight of the liquid crystal display device at 25° C. and relative humidity of 60% for 5 hours, and the evaluation result of the amount of light leakage and warp unevenness was same as that of a case of lighting the backlight of the liquid crystal display device at 25° C. and relative humidity of 60% for 5 hours.

It is preferable that the evaluation is A, B, or C, it is more preferable that the evaluation is A or B, and it is particularly preferable that the evaluation is A.

TABLE 1

| | | Configuration of Polarization Plate | | | | | | | |
|---|---|---|---|---|---|---|---|---|---|
| | | First Protective Film | | | | | | | |
| | | | | Modulus of Elasticity | | | | | |
| | | | | (25° C. 60%) | | | | | |
| | | | | | | Ratio of | | | |
| | | | | | | Moduli | Polarizer | Second Protective Film | |
| | | | Film | | | of | Direction | | Film |
| | | | Thickness | | | Elasticity | of | | Thickness |
| | Polarization | | d1 | MD | TD | MD/TD | Absorption | | d2 |
| | Plate Name | Type | [μm] | [GPa] | [GPa] | — | Axis | Type | [μm] |
| Example | Polarization | Stretched PET | 100 | 2.8 | 72 | 0.39 | MD | Stretched | 40 |
| 101 | Plate 101 | 100 μm | | | | | | DAC 40 μm | |
| Example | Polarization | Stretched PET | 100 | 2.8 | 7.2 | 0.39 | MD | Stretched | 35 |
| 102 | Plate 102 | 100 μm | | | | | | DAC 35 μm | |
| Example | Polarization | Stretched PET | 80 | 2.8 | 7.2 | 0.39 | MD | Stretched | 40 |
| 103 | Plate 103 | 80 μm | | | | | | DAC 40 μm | |
| Example | Polarization | Stretched PET | 80 | 2.8 | 7.2 | 0.39 | MD | Stretched | 35 |
| 104 | Plate 104 | 80 μm | | | | | | DAC 35 μm | |
| Example | Polarization | Stretched PET | 60 | 2.8 | 7.2 | 0.39 | MD | Stretched | 35 |
| 105 | Plate 105 | 60 μm | | | | | | DAC 35 μm | |
| Example | Polarization | Stretched PET | 60 | 2.8 | 7.2 | 0.39 | MD | Stretched | 30 |
| 106 | Plate 106 | 60 μm | | | | | | DAC 30 μm | |
| Example | Polarization | HC | 80 | 2.8 | 7.2 | 0.39 | MD | Stretched | 35 |
| 108 | Plate 108 | Layer-Attached | | | | | | DAC 35 μm | |
| | | Stretched PET | | | | | | | |
| | | 80 μm | | | | | | | |
| Example | Polarization | Three-Layer | 80 | 2.8 | 7.2 | 0.39 | MD | Stretched | 35 |
| 109 | Plate 109 | Co-Extrusion | | | | | | DAC 35 μm | |
| | | Stretched PET | | | | | | | |
| | | 80 μm | | | | | | | |
| Comparative | Polarization | Stretched PET | 80 | 2.8 | 7.2 | 0.39 | MD | Stretched | 65 |
| Example | Plate 110 | 80 μm | | | | | | DAC 65 μm | |
| 101 | | | | | | | | | |
| Comparative | Polarization | 80 μm PET-A | 80 | 4.7 | 5.1 | 0.92 | MD | Stretched | 65 |
| Example | Plate 111 | | | | | | | DAC 65 μm | |
| 102 | | | | | | | | | |

| | Configuration of Polarization Plate | | | | | | | |
|---|---|---|---|---|---|---|---|---|
| | Second Protective Film | | | | | | | |
| | Modulus of Elasticity | | | | | | | |
| | (25° C. 60%) | | | Modulus | | | | |
| | | | Ratio of | of | | Evaluation | | |
| | | | Moduli | Elasticity | Film | | Liquid Crystal | |
| | | | of | (70° C. | Thickness | Polarization | Display Device | |
| | | | Elasticity | 60%) | Ratio | Plate | | Unevenness |
| | MD | TD | MD/TD | MD | d2/d1 | MD | Rainbow | of Front |
| | [GPa] | [GPa] | — | [GPa] | — | Curling | Unevenness | Surface |
| Example | 3.6 | 5.5 | 0.65 | 1.0 | 0.40 | C | A | A |
| 101 | | | | | | | | |
| Example | 3.6 | 5.5 | 0.65 | 1.0 | 0.35 | B | A | A |
| 102 | | | | | | | | |
| Example | 3.6 | 5.5 | 0.65 | 1.0 | 0.51 | C | A | A |
| 103 | | | | | | | | |
| Example | 3.6 | 5.5 | 0.65 | 1.0 | 0.44 | B | A | A |
| 104 | | | | | | | | |
| Example | 3.6 | 5.5 | 0.65 | 1.0 | 0.58 | C | B | A |
| 105 | | | | | | | | |
| Example | 3.6 | 5.5 | 0.65 | 1.0 | 0.50 | B | B | A |
| 106 | | | | | | | | |
| Example | 3.6 | 5.5 | 0.65 | 1.0 | 0.44 | A | A | A |
| 108 | | | | | | | | |
| Example | 3.6 | 5.5 | 0.65 | 1.0 | 0.44 | B | A | A |
| 109 | | | | | | | | |
| Comparative | 3.6 | 5.5 | 0.65 | 1.0 | 0.81 | D | A | A |
| Example | | | | | | | | |
| 101 | | | | | | | | |
| Comparative | 3.6 | 5.5 | 0.65 | 1.0 | 0.81 | D | C | A |
| Example | | | | | | | | |
| 102 | | | | | | | | |

In Table 1 described above, the results of a case where a cellulose acylate (DAC) film having a low degree of acyl substitution was used as the second protective film are shown.

In Examples 101 to 106, it was found that the cellulose acylate (DAC) film having a low degree of acyl substitution which was used as the second protective film was excellent as the thickness of the film became thinner from a viewpoint of curling.

In Example 108, it was found that the minus curling was suppressed by applying a hard coat (the HC layer) to the first protective film.

In Example 109, it was found that the curling value was not changed even when the manufacturing method of the PET film used as the first protective film was different.

In Examples 101 to 106, 108, and 109, it was found that when the cellulose acylate (DAC) film having a low degree of acyl substitution was used as the second protective film on a side (the inner side) close to the liquid crystal cell at the time of incorporating the polarization plate in the liquid crystal display device, the liquid crystal display device having excellent unevenness of a front surface resistance was obtained.

In contrast, in Comparative Example 101, it was found that when the film thickness of the second protective film was greater than the upper limit value set in the present invention, and the film thickness ratio d1/d2 of the first protective film to the second protective film was also greater than the upper limit value set in the present invention, the curling of the polarization plate in the MD direction was not able to be suppressed.

In Comparative Example 102, it was found that when the modulus of elasticity of the first protective film in the MD direction was greater than the upper limit value set in the present invention, a ratio of the modulus of elasticity of the first protective film in the MD direction to the modulus of elasticity of the first protective film in the TD direction was greater than the upper limit value set in the present invention, the film thickness of the second protective film was greater than the upper limit value set in the present invention, and the film thickness ratio d1/d2 of the first protective film to the second protective film was also greater than the upper limit value set in the present invention, the curling of the polarization plate in the MD direction was not able to be suppressed.

TABLE 2

| | | Configuration of Polarization Plate | | | | | | | |
|---|---|---|---|---|---|---|---|---|---|
| | | First Protective Film | | | | | | | |
| | | | | Modulus of Elasticity | | | | | |
| | | | | (25° C. 60%) | | | | Second | |
| | | | | | | Ratio of | | Protective | |
| | | | | | | Moduli | Polarizer | Film | |
| | | | Film | | | of | Direction | | Film |
| | | | Thickness | | | Elasticity | of | | Thickness |
| | Polarization | | d1 | MD | TD | MD/TD | Absorption | | d2 |
| | Plate Name | Type | [μm] | [GPa] | [GPa] | — | Axis | Type | [μm] |
| Example | Polarization | Stretched | 100 | 2.8 | 72 | 0.39 | MD | Stretched | 40 |
| 201 | Plate 201 | PET 100 μm | | | | | | CAP 40 μm | |
| Example | Polarization | Stretched | 100 | 2.8 | 7.2 | 0.39 | MD | Stretched | 35 |
| 202 | Plate 202 | PET 100 μm | | | | | | CAP 35 μm | |
| Example | Polarization | Stretched | 80 | 2.8 | 7.2 | 0.39 | MD | Stretched | 40 |
| 203 | Plate 203 | PET 80 μm | | | | | | CAP 40 μm | |
| Example | Polarization | Stretched | 80 | 2.8 | 7.2 | 0.39 | MD | Stretched | 35 |
| 204 | Plate 204 | PET 80 μm | | | | | | CAP 35 μm | |
| Example | Polarization | Stretched | 60 | 2.8 | 7.2 | 0.39 | MD | Stretched | 35 |
| 205 | Plate 205 | PET 60 μm | | | | | | CAP 35 μm | |
| Example | Polarization | Stretched | 60 | 2.8 | 7.2 | 0.39 | MD | Stretched | 30 |
| 206 | Plate 206 | PET 60 μm | | | | | | CAP 30 μm | |
| Comparative | Polarization | Stretched | 80 | 2.8 | 7.2 | 0.39 | MD | Stretched | 65 |
| Example | Plate 208 | PET 80 μm | | | | | | CAP 65 μm | |
| 201 | | | | | | | | | |
| Comparative | Polarization | 80 μm | 80 | 4.7 | 5.1 | 0.92 | MD | Stretched | 65 |
| Example | Plate 209 | PET-A | | | | | | CAP 65 μm | |
| 202 | | | | | | | | | |

| | Configuration of Polarization Plate | | | | | | | |
|---|---|---|---|---|---|---|---|---|
| | Second Protective Film | | | | | | | |
| | Modulus of Elasticity | | | | | | | |
| | (25° C. 60%) | | | Modulus | | | | |
| | | | Ratio of | of | | Evaluation | | |
| | | | Moduli | Elasticity | Film | | Liquid Crystal | |
| | | | of | (70° C. | Thickness | Polarization | Display Device | |
| | | | Elasticity | 60%) | Ratio | Plate | | Unevenness |
| | MD | TD | MD/TD | MD | d2/d1 | MD | Rainbow | of Front |
| | [GPa] | [GPa] | — | [GPa] | — | Curling | Unevenness | Surface |
| Example | 3.1 | 4.6 | 0.67 | 2.0 | 0.40 | B | A | C |
| 201 | | | | | | | | |
| Example | 3.1 | 4.6 | 0.67 | 2.0 | 0.35 | A | A | C |
| 202 | | | | | | | | |
| Example | 3.1 | 4.6 | 0.67 | 2.0 | 0.51 | B | A | C |
| 203 | | | | | | | | |
| Example | 3.1 | 4.6 | 0.67 | 2.0 | 0.44 | A | A | C |
| 204 | | | | | | | | |
| Example | 3.1 | 4.6 | 0.67 | 2.0 | 0.58 | A | B | C |
| 205 | | | | | | | | |
| Example | 3.1 | 4.6 | 0.67 | 2.0 | 0.50 | A | B | C |
| 206 | | | | | | | | |
| Comparative | 3.1 | 4.6 | 0.67 | 2.0 | 0.81 | D | A | C |
| Example | | | | | | | | |
| 201 | | | | | | | | |
| Comparative | 3.1 | 4.6 | 0.67 | 2.0 | 0.81 | D | C | C |
| Example | | | | | | | | |
| 202 | | | | | | | | |

In Table 2 described above, the results of a case where a cellulose acylate propionate (CAP) film was used as the second protective film are shown.

In Examples 201 to 206, it was found that the cellulose acylate propionate (CAP) film used as the second protective film was excellent as the thickness of the film became thinner from a viewpoint of curling.

In Examples 201 to 206, it was found that when the cellulose acylate propionate (CAP) film was used as the second protective film on a side (the inner side) close to the liquid crystal cell at the time of incorporating the polarization plate in the liquid crystal display device, the curling score was excellent.

In contrast, in Comparative Example 201, it was found that when the film thickness of the second protective film was greater than the upper limit value set in the present invention, and the film thickness ratio d1/d2 of the first protective film to the second protective film was also greater than the upper limit value set in the present invention, the curling of the polarization plate in the MD direction was not able to be suppressed.

In Comparative Example 202, it was found that when the modulus of elasticity of the first protective film in the MD direction was greater than the upper limit value set in the present invention, a ratio of the modulus of elasticity of the first protective film in the MD direction to the modulus of elasticity of the first protective film in the TD direction was greater than the upper limit value set in the present invention, the film thickness of the second protective film was greater than the upper limit value set in the present invention, and the film thickness ratio d1/d2 of the first protective film to the second protective film was also greater than the upper limit value set in the present invention, the curling of the polarization plate in the MD direction was not able to be suppressed.

TABLE 3

| | | Configuration of Polarization Plate | | | | | | | |
|---|---|---|---|---|---|---|---|---|---|
| | | First Protective Film | | | | | | | |
| | | | | Modulus of Elasticity | | | | | |
| | | | | (25° C. 60%) | | | | | |
| | | | | | | Ratio of | | | |
| | | | | | | Moduli | Polarizer | Second Protective Film | |
| | | | Film | | | of | Direction | | Film |
| | | | Thickness | | | Elasticity | of | | Thickness |
| | Polarization | | d1 | MD | TD | MD/TD | Absorption | | d2 |
| | Plate Name | Type | [μm] | [GPa] | [GPa] | — | Axis | Type | [μm] |
| Example | Polarization | Stretched | 100 | 2.8 | 72 | 0.39 | MD | Stretched | 40 |
| 301 | Plate 301 | PET 100 μm | | | | | | TAC 40 μm | |
| Example | Polarization | Stretched | 100 | 2.8 | 7.2 | 0.39 | MD | Stretched | 35 |
| 302 | Plate 302 | PET 100 μm | | | | | | TAC 35 μm | |
| Example | Polarization | Stretched | 80 | 2.8 | 7.2 | 0.39 | MD | Stretched | 40 |
| 303 | Plate 303 | PET 80 μm | | | | | | TAC 40 μm | |
| Example | Polarization | Stretched | 80 | 2.8 | 7.2 | 0.39 | MD | Stretched | 35 |
| 304 | Plate 304 | PET 80 μm | | | | | | TAC 35 μm | |
| Example | Polarization | Stretched | 60 | 2.8 | 7.2 | 0.39 | MD | Stretched | 35 |
| 305 | Plate 305 | PET 60 μm | | | | | | TAC 35 μm | |
| Example | Polarization | Stretched | 60 | 2.8 | 7.2 | 0.39 | MD | Stretched | 30 |
| 306 | Plate 306 | PET 60 μm | | | | | | TAC 30 μm | |
| Comparative | Polarization | Stretched | 80 | 2.8 | 7.2 | 0.39 | MD | Stretched | 65 |
| Example | Plate 307 | PET 80 μm | | | | | | TAC 65 μm | |
| 301 | | | | | | | | | |
| Comparative | Polarization | 80 μm | 80 | 4.7 | 5.1 | 0.92 | MD | Stretched | 65 |
| Example | Plate 308 | PET-A | | | | | | TAC 65 μm | |
| 302 | | | | | | | | | |

| | Configuration of Polarization Plate | | | | | | | |
|---|---|---|---|---|---|---|---|---|
| | Second Protective Film | | | | | | | |
| | Modulus of Elasticity | | | | | | | |
| | (25° C. 60%) | | | | | | | |
| | | | Ratio of | | | Evaluation | | |
| | | | Moduli | Modulus of | Film | | Liquid Crystal Display | |
| | | | of | Elasticity | Thickness | Polarization | Device | |
| | | | Elasticity | (70° C. 60%) | Ratio | Plate | | Unevenness |
| | MD | TD | MD/TD | MD | d2/d1 | MD | Rainbow | of Front |
| | [GPa] | [GPa] | — | [GPa] | — | Curling | Unevenness | Surface |
| Example | 3.8 | 4.4 | 0.86 | 1.9 | 0.40 | C | A | B |
| 301 | | | | | | | | |
| Example | 3.8 | 4.4 | 0.86 | 1.9 | 0.35 | B | A | B |
| 302 | | | | | | | | |
| Example | 3.8 | 4.4 | 0.86 | 1.9 | 0.51 | C | A | B |
| 303 | | | | | | | | |
| Example | 3.8 | 4.4 | 0.86 | 1.9 | 0.44 | B | A | B |
| 304 | | | | | | | | |
| Example | 3.8 | 4.4 | 0.86 | 1.9 | 0.58 | C | B | B |
| 305 | | | | | | | | |
| Example | 3.8 | 4.4 | 0.86 | 1.9 | 0.50 | C | B | B |
| 306 | | | | | | | | |
| Comparative | 3.8 | 4.4 | 0.86 | 1.9 | 0.81 | D | A | B |
| Example | | | | | | | | |
| 301 | | | | | | | | |
| Comparative | 3.8 | 4.4 | 0.86 | 1.9 | 0.81 | D | C | B |
| Example | | | | | | | | |
| 302 | | | | | | | | |

In Table 3 described above, the results of a case where a cellulose acylate (TAC) film having a high degree of acyl substitution was used as the second protective film are shown.

In Examples 301 to 306, it was found that the cellulose acylate (TAC) film having a high degree of acyl substitution which was used as the second protective film was excellent as the thickness of the film became thinner from a viewpoint of curling.

In contrast, in Comparative Example 301, it was found that when the film thickness of the second protective film was greater than the upper limit value set in the present invention, and the film thickness ratio d1/d2 of the first protective film to the second protective film was also greater than the upper limit value set in the present invention, the curling of the polarization plate in the MD direction was not able to be suppressed.

In Comparative Example 302, it was found that when the modulus of elasticity of the first protective film in the MD direction was greater than the upper limit value set in the present invention, a ratio of the modulus of elasticity of the first protective film in the MD direction to the modulus of elasticity of the first protective film in the TD direction was greater than the upper limit value set in the present invention, the film thickness of the second protective film was greater than the upper limit value set in the present invention, and the film thickness ratio d1/d2 of the first protective film to the second protective film was also greater than the upper limit value set in the present invention, the curling of the polarization plate in the MD direction was not able to be suppressed.

### EXPLANATION OF REFERENCES

1: first protective film
2: second protective film
3: polarizer second protective film
11: adhesive layer 1
12: adhesive layer 2
14: easily adhesive layer
15: hard coat layer
20: polarization plate
21: visible side polarization plate
22: liquid crystal cell
23: backlight side polarization plate
23a: protective film of backlight side polarization plate
23b: polarizer of backlight side polarization plate
26: backlight
30: image display device

What is claimed is:

1. A polarization plate, comprising:
a polarizer having polarization performance;
a first protective film bonded to one surface of the polarizer through an adhesive layer 1; and
a second protective film bonded to the other surface of the polarizer through an adhesive layer 2,
wherein a modulus of elasticity of the first protective film at 25° C. and relative humidity of 60% in an absorption axis direction of the polarizer is greater than or equal to 1.0 GPa and less than 4.0 GPa,
a ratio of the modulus of elasticity of the first protective film at 25° C. and relative humidity of 60% in the absorption axis direction of the polarizer to a modulus of elasticity of the first protective film at 25° C. and relative humidity of 60% in a direction orthogonal to the absorption axis of the polarizer is less than or equal to 0.8,
a modulus of elasticity of the second protective film at 25° C. and relative humidity of 60% in the absorption axis direction of the polarizer is greater than or equal to 2.0 GPa and less than 5.0 GPa, and
(Expression 1) and (Expression 2) described below are satisfied.
d2/d1≦0.8 (Expression 1)
d2≦40 μm (Expression 2)
wherein d1 represents a thickness of the first protective film with a unit of μm, and d2 represents a thickness of the second protective film with a unit of μm.

2. The polarization plate according to claim 1,
wherein the first protective film is a film containing a polyester resin or a polycarbonate resin as a main component.

3. The polarization plate according to claim 1,
wherein a ratio of the modulus of elasticity of the second protective film at 25° C. and relative humidity of 60% in the absorption axis direction of the polarizer to a modulus of elasticity of the second protective film at 25° C. and relative humidity of 60% in the direction orthogonal to the absorption axis of the polarizer is greater than or equal to 0.6 and less than 1.1.

4. The polarization plate according to claim 1,
wherein the second protective film contains a cellulose-based resin.

5. The polarization plate according to claim 4,
wherein a degree of substitution of an acyl group of the cellulose-based resin contained in the second protective film is greater than or equal to 2.0 and less than 2.6.

6. A method for manufacturing a polarization plate, comprising:
bonding a first protective film to one surface of a polarizer having polarization performance through an adhesive layer 1; and
bonding a second protective film to the other surface of the polarizer through an adhesive layer 2,
wherein a modulus of elasticity of the first protective film at 25° C. and relative humidity of 60% in an absorption axis direction of the polarizer is greater than or equal to 1.0 GPa and less than 4.0 GPa,
a ratio of the modulus of elasticity of the first protective film at 25° C. and relative humidity of 60% in the absorption axis direction of the polarizer to a modulus of elasticity of the first protective film at 25° C. and relative humidity of 60% in a direction orthogonal to the absorption axis of the polarizer is less than or equal to 0.8,
a modulus of elasticity of the second protective film at 25° C. and relative humidity of 60% in the absorption axis direction of the polarizer is greater than or equal to 2.0 GPa and less than 5.0 GPa, and
(Expression 1) and (Expression 2) described below are satisfied.
d2/d1≦0.8 (Expression 1)
d2≦40 μm (Expression 2)
wherein d1 represents a thickness of the first protective film with a unit of μm, and d2 represents a thickness of the second protective film with a unit of μm.

7. The method for manufacturing a polarization plate according to claim 6,
wherein a modulus of elasticity of the second protective film at 70° C. and relative humidity of 60% in the absorption axis direction of the polarizer is greater than or equal to 1.5 GPa and less than or equal to 3.0 GPa, and
a main component of the adhesive layer 1 and the adhesive layer 2 is an aqueous adhesive agent.

8. An image display device comprising the polarization plate according to claim 1.
